(19) United States
(12) Patent Application Publication
(10) Pub. No.: US 2016/0265097 A1
(43) Pub. Date: Sep. 15, 2016

(54) MOLTEN METAL PLATING FURNACE, SYSTEM FOR PRODUCING AND METHOD FOR PRODUCING PLATED PRODUCT, AND METAL PLATED STEEL TUBE OBTAINED BY MEANS OF SAID METHOD FOR PRODUCING

(71) Applicant: DAIWA STEEL TUBE INDUSTRIES CO., LTD, Sakura-shi, Tochigi (JP)

(72) Inventors: Shinichiro NAKAMURA, Sakura-shi, Tochigi (JP); Mutsumu TANIMOTO, Sakura-shi, Tochigi (JP); Atsushi YAMADA, Sakura-shi, Tochigi (JP)

(21) Appl. No.: 15/033,087

(22) PCT Filed: Oct. 30, 2014
(86) PCT No.: PCT/JP2014/078907

§ 371 Date: Apr. 28, 2016

(30) Foreign Application Priority Data
Nov. 1, 2013 (JP) 2013-227858
May 20, 2014 (JP) 2014-104442

(51) Int. Cl. C23C 2/00; C23C 26/02; F16L 9/02; C23C 2/38

(52) U.S. Cl. CPC C23C 2/003; C23C 2/38; C23C 26/02; F16L 9/02; C23C 2/06

(57) ABSTRACT

[Problem] To provide: a molten metal plating furnace that can increase plating quality and work efficiency; a system for producing and method for producing a metal plated product; and a metal plated steel tube obtained by means of the method for producing. [Solution] The system for producing has at least one plating implementation unit that performs molten metal plating of a plating processing subject, and at least one plating implementation unit has a plating bath and a heating device for heating the plating bath, wherein in the heating device, an array of fuel filling openings and an array of air filling openings are formed that are facing in a manner so as to discharge air and fuel to a combustion region in common along a combustion chamber, the effective opening cross-sectional size of at least the majority of the openings of at least one of the opening arrays can be adjusted by means of an adjustment mechanism for adjusting the extent of a medium filling opening array, and when the size of both opening arrays can be adjusted, individual adjustment of the arrays is possible.

### BACKGROUND

1. Technical Field

The present invention relates to a molten metal plating furnace, especially relating to a molten metal plating furnace which is capable of diminishing variation in temperature of molten metal in a plating bath and reducing the amount of consumed gas. Further, the present invention relates to a system and a method for producing a metal-plated product capable of improving work efficiency and plating quality by incorporating the molten metal plating furnace.

2. Related Art

A molten metal plating furnace is used for dipping a metal plating treatment object into molten metal stored in a plating bath so as to apply a plating treatment to the same. For example, a molten zinc plating bath of a double wall structure constituted of an inner wall and an outer wall has been known, in which the inner wall is heated by a burner installed on the outer wall at intervals, keeping zinc stored in the plating bath inside the inner wall in a molten state (refer to Patent Document 1).

However, in such a molten zinc plating bath, or in a plating furnace 200 which is provided with burners 210 illustrated in FIG. 12 at two places of a heat-resistant outer wall 204, parts thereof, with which flame jetted from flame ports of the burner directly come into contact, locally become higher in temperature, and the temperature at an intermediate position between adjacent burners becomes lower, thereby causing variation in temperature of the molten zinc in the plating bath. This causes a problem that a zinc deposition amount becomes less in low temperature parts, consequently, a uniform zinc plating film is not formed. Furthermore, this plating bath heating method has problems that the temperature in the furnace becomes higher, the life of the plating bath becomes shorter, and that the costs become higher due to an increased number of combustion instruments such as burners being required in a larger number.

Moreover, a molten zinc plating furnace which heats a plating bath thereof by combustion gas which circulates in one direction in a combustion chamber of the molten zinc plating furnace in which high-velocity burners are provided in one end portion of a short wall portion thereof and a portion which is positioned diagonally to the same and at the intermediate position between two opposed long wall portions thereof, is disclosed (refer to Patent Document 2).

In this molten zinc plating furnace, as the combustion gas jetted from the high-velocity burners circulates in one direction in the combustion chamber so as to generate convection heat transfer heating, variation in temperature in the plating bath can be suppressed to some extent so as to make the temperature in the furnace lower than that in the conventional plating furnace. However, as its heating method is that the combustion gas is turned into flame and jetted into the combustion chamber from flame ports so as to heat molten zinc, the jetted gas itself needs to be high in temperature. Therefore, progress of corrosion in the furnace cannot be suppressed. Furthermore, a large amount of gas is needed in order to put the furnace in a high temperature state.

### [Patent Document 1]

Japanese Utility Model Application Laid-Open No. S56-28064

### [Patent Document 2]

Japanese Patent Application Laid-Open No. 2005-264314

### SUMMARY

As described above, the conventional molten metal plating furnace has problems such as oxidation corrosion of an outer wall of the pot occurs since molten metal in the plating bath locally becomes higher in temperature which applies heavy load on the pot (plating bath) in which metal melts, and alloying and dross occur at a contact portion with the molten metal on an inner wall of the pot, and a uniform plating is difficult to be applied and gas consumption amount is large since variation occurs in temperature of the molten metal, and the like. Similarly, when a plating system is constituted based on a conventional molten metal plating furnace, there arise problems of decreased work efficiency and the occurrence of variation in plating quality resulting from the above problems. The present invention is intended to solve these problems.

The inventors of the present invention found that, by employing a heating method of a new technology, which has not been applied in a molten metal plating furnace, to the molten metal plating furnace, metal can be molten without putting the jetted gas itself into high temperature as in the conventional manner, and temperature distribution of the molten metal can be uniformed, and further the gas consumption amount can be suppressed. Further, the inventors of the present invention found that, by properly incorporating the molten metal furnace into a system for producing a metal-plated product, the work efficiency of the system and plating quality can be improved, leading to the perfection of the present invention.

Namely, the molten metal plating furnace of the present invention has a plating bath, an inner wall disposed outside of the plating bath, a heat-resistant outer wall in a substantially rectangular shape made of a short wall portion and a long wall portion, and a heating chamber surrounded by the inner wall and the heat-resistant outer wall, a heating device disposed on at least one place of the heat-resistant outer wall, in which

the heating device is the combustor (10) having a combustion chamber (12) extending regularly about a central axis (14) and of which at least part of the axially extending wall (26, 64, 66) is formed with an array (22) of fuel charging orifices (28.1) and an array (24) of air charging orifices (28.2) facing to discharge fuel and air into a common combustion zone along the combustion chamber (12) with the sizes of the fuel charging orifices (28.1) standing in an appropriate relationship to those of the air charging orifices (28.2) to achieve an effective combustion reaction, a progressively constricted combusted medium discharge nozzle (16) for accelerating the discharge velocity of combusted medium, and a combustion fuel and air supply disposition (20, 18) opening respectively into the fuel charging orifice array (22) and the air charging orifice array (24) each being connectable to a supply of the relevant medium, whether fuel or air, while the combustion chamber (12) is exposable to igniting means (34) for igniting a combustible mixture once the combustor is in use; characterised in that the effective cross sectional orifice size of at least the majority of orifices (28) of at least one of the orifice arrays (22, 24) is controllably adjustable by means of an adjustment mechanism (30, 44, 46, 48, 58, 68, 70, 76) for adjusting the extent of the appropriate medium charging orifice array (22, 24) though enabling the independent adjustment of the arrays in the case of the sizes of both the orifice arrays being adjustable.

In addition, the system of the present invention for producing a metal-plated product has at least one plating performing part (plating performing unit) that performs molten metal plating on an object to be plated, in which

at least one of the plating performing part includes a plating bath and a heating device to heat the plating bath; and

the heating device is the combustor (10) having a combustion chamber (12) extending regularly about a central axis (14) and of which at least part of the axially extending wall (26, 64, 66) is formed with an array (22) of fuel charging orifices (28.1) and an array (24) of air charging orifices (28.2) facing to discharge fuel and air into a common combustion zone along the combustion chamber (12) with the sizes of the fuel charging orifices (28.1) standing in an appropriate relationship to those of the air charging orifices (28.2) to achieve an effective combustion reaction, a progressively constricted combusted medium discharge nozzle (16) for accelerating the discharge velocity of combusted medium, and a combustion fuel and air supply disposition (20, 18) opening respectively into the fuel charging orifice array (22) and the air charging orifice array (24) each being connectable to a supply of the relevant medium, whether fuel or air, while the combustion chamber (12) is exposable to igniting means (34) for igniting a combustible mixture once the combustor is in use; characterised in that the effective cross sectional orifice size of at least the majority of orifices (28) of at least one of the orifice arrays (22, 24) is controllably adjustable by means of an adjustment mechanism (30, 44, 46, 48, 58, 68, 70, 76) for adjusting the extent of the appropriate medium charging orifice array (22, 24) though enabling the independent adjustment of the arrays in the case of the sizes of both the orifice arrays being adjustable.

Here, the present system of the present invention for producing a metal-plated product may be the system having the molten metal plating furnace having a plating bath, an inner wall disposed outside of the plating bath, a heat-resistant outer wall in a substantially rectangular shape made of a short wall portion and a long wall portion, and a heating chamber surrounded by the inner wall and the heat-resistant outer wall, a heating device disposed on at least one place of the heat-resistant outer wall, in which

the heating device is the combustor (10) having a combustion chamber (12) extending regularly about a central axis (14) and of which at least part of the axially extending wall (26, 64, 66) is formed with an array (22) of fuel charging orifices (28.1) and an array (24) of air charging orifices (28.2) facing to discharge fuel and air into a common combustion zone along the combustion chamber (12) with the sizes of the fuel charging orifices (28.1) standing in an appropriate relationship to those of the air charging orifices (28.2) to achieve an effective combustion reaction, a progressively constricted combusted medium discharge nozzle (16) for accelerating the discharge velocity of combusted medium, and a combustion fuel and air supply disposition (20, 18) opening respectively into the fuel charging orifice array (22) and the air charging orifice array (24) each being connectable to a supply of the relevant medium, whether fuel or air, while the combustion chamber (12) is exposable to igniting means (34) for igniting a combustible mixture once the combustor is in use; characterised in that the effective cross sectional orifice size of at least the majority of orifices (28) of at least one of the orifice arrays (22, 24) is controllably adjustable by means of an adjustment mechanism (30, 44, 46, 48, 58, 68, 70, 76) for adjusting the extent of the appropriate medium charging orifice array (22, 24) though enabling the independent adjustment of the arrays in the case of the sizes of both the orifice arrays being adjustable.

Here, the individual orifices (28) of the arrays (22, 24) of the heating device may be positioned and aimed to result in the central axes (40) of at least the majority of air charging orifices (28.2) crossing the central axes (38) of corresponding fuel charging orifices (28.1) along the longitudinal centre (14, 42) of the combustion chamber (12) that corresponds with its the central axis (14).

The medium charging orifice arrays (22,24) of the heating device each may have an equal number of orifices (28).

The orifices (28) of the arrays (22,24) of the heating device may be regularly spaced.

The orifices (28) of the arrays (22, 24) of the heating device may be spaced in rows and columns.

All the central axis (38,40) of the orifices (28) of the heating device may be slanted at the same angle relative to the longitudinal centre (14, 42) of the combustion chamber (12) in the discharge direction of the heating device.

The adjustment mechanism (30, 44, 46, 48, 58, 68, 70, 76) of the heating device may include covering means (30, 44, 58, 68, 70) for the at least one adjustable medium charging orifice array (22, 24) formed with a covering means orifice array (32, 72, 74) matching that of the medium charging orifice array (22, 24) it adjustably co-acts with in response to the relative parallel displacement of the covering means and the medium charging array presenting walls (26, 64, 66) of the combustion chamber (12), as lying snugly against one another, between conditions of at least extensive orifice registration and constricted orifice registration thereby to adjust the flow of relevant medium into the combustion chamber during use of the combustor.

The combustion chamber (12) of the heating device may be constituted to cause the medium charging orifice arrays (22, 24) to face one another.

The combustion chamber (12) of the heating device may be annularly formed about a centrally extending medium charging chamber (a) along which the central axis (14) extends resulting in its longitudinal centre (42) extending centrally annularly within the combustion chamber (12) causing the medium charging orifice arrays (22, 24) to extend along the facing circumferential walls (26.1, 26.2) defining the longitudinal inner and outer side walls of the medium charging chamber (a) with the inner end of the chamber being appropriately blanked off.

The orifice size of the at least one medium charging array (22, 24) of the heating device may be adjustable in response to the covering means (30), as in the form of a cylindrically shaped covering body (30, 44, 58), being mounted to be slidably displaced along the surface of the relevant combustion chamber defining wall (26) remote from the combustion chamber, whether within the medium charging chamber (a) or along the outside of the outer longitudinally extending combustion chamber encompassing wall (26.2).

The covering body (44, 58) of the heating device may be mounted to be controllably displaced in the direction of the central axis (14) of the heating device.

Both medium charging orifice arrays (22, 24) of the heating device may be adjustable via orifice cylindrically shaped covering bodies (44, 58).

The combustion fuel and air supply disposition (18, 20) of the heating device may be in the form of appropriately replenishable charging chambers the one extending within the inside longitudinal wall (26.1) and the other along the outside wall (26.2) of the combustion chamber.

The fuel charging chamber (20) of the heating device may be situated within the combustion chamber (12) and the air charging chamber (18) of the heating device along its outside.

The combustion chamber (12) of the heating device, as appropriately blanked off at its inner end, may extend along the central axis (14) as thus defining its longitudinal centre (42), the adjustment mechanism (30, 44, 68, 70, 76) when in the form of covering means that adjustably co-acts with the at least one medium charging orifice array (22, 24) in adjusting its orifice size, being slidably mounted to the outside surface of the appropriate longitudinal wall (26, 64, 66) of the combustion chamber (12).

The combustion fuel and air supply disposition (18, 20) of the heating device may be in the form of appropriately replenishable charging chambers extending alongside the side walls (64, 66) of the combustion chamber.

The combustion chamber (12) of the heating device is formed with planar side walls of which at least some may be formed with medium charging orifices (28).

The covering means (30, 68, 70) of the heating device may be in the form of at least one orifice covering plate (68, 70) mounted to be displaced between stops in the direction of the central axis (14) of the combustion chamber.

The combustion chamber (12) of the heating device may be rectangularly shaped.

Two facing side walls (68, 70) of the combustion chamber of the heating device may be formed with medium charging orifices (28), the one thus with the air and the other with the fuel charging orifices.

Both the air and fuel charging orifice arrays (24, 22) of the heating device may be adjustable via appropriately orifice covering plates (68, 70).

In addition, the molten metal plated product may be a metal-plated steel pipe.

Furthermore, the system may be the system that manufactures a steel pipe, of which inner and outer faces or any one face thereof is subjected to molten metal-plating, from a steel sheet in a continuous manufacturing line, the system comprising:

an inner-face plating performing part that performs molten metal-plating by pouring molten metal to the upper side of the steel sheet corresponding to the inner face of the steel pipe;

a steel pipe forming part for obtaining a continuous steel pipe by continuously cold-forming the steel sheet subjected to the inner-face plating into a tubular shape and seam-welding a longitudinal end face joint portion of the steel sheet formed in the steel pipe; and

an outer-face plating performing part that performs molten metal-plating by dipping the outer face of the steel pipe into molten metal,

in which the inner-face plating performing part and/or the outer-face plating performing part include the plating bath and the heating device to heat the plating bath.

Furthermore, the system may be the system that manufactures a steel pipe, of which at least an inner face thereof is subjected to molten metal-plating, from a steel sheet in a continuous manufacturing line, the system comprising:

an inner-face plating performing part that performs molten metal-plating by pouring molten metal to the upper side of the steel sheet corresponding to the inner face of the steel pipe; and

a steel pipe forming part for obtaining a continuous steel pipe by continuously cold-forming the steel sheet subjected to the inner-face plating into a tubular shape and seam-welding a longitudinal end face joint portion of the steel sheet formed in the steel pipe,

in which the inner-face plating performing part includes:

a pouring part that pours molten metal to the upper side of the steel sheet,

a molten metal supply part that can supply molten metal to the pouring part, and

an inner-face wiping part that removes molten metal poured by the pouring part,

in which the pouring part has a movable means that is movable in parallel to a direction where the steel sheet advances;

a relative distance between an initial molten metal pouring position and a position of the inner-face wiping part is adjustable; and

the inner-face plating performing part include the plating bath and the heating device to heat the plating bath.

Additionally, the system may be the system that manufactures a steel pipe, of which at least an outer face thereof is subjected to molten metal-plating, from a steel sheet in a continuous manufacturing line, the system comprising:

a steel pipe forming part for obtaining a continuous steel pipe by continuously cold-forming the steel sheet into a tubular shape and seam-welding a longitudinal end face joint portion of the steel sheet formed in the steel pipe; and

an outer-face plating performing part that performs molten metal-plating by dipping the outer face of the steel pipe into molten metal,

in which the outer-face plating performing part includes:

a dipping part that allows the molten metal to pass through the steel pipe so as to perform a molten metal-plating treatment thereon,

a molten metal supply part that can supply the molten metal to the dipping part, and

an outer-face wiping part that removes surplus metal from the continuous steel pipe dipped into the molten metal by the dipping part,

in which the dipping part has a movable means that is movable in parallel to a direction where the steel sheet advances;

a relative distance between an initial molten metal dipping position and a position of the outer-face wiping part is adjustable; and

the outer-face plating performing part include the plating bath and the heating device to heat the plating bath.

In addition, the system may be the system that manufactures a steel pipe, of which inner and outer faces thereof are subjected to molten metal-plating, from a steel sheet in a continuous manufacturing line, the system comprising:

an inner-face plating performing part that performs molten metal-plating by pouring molten metal to the upper side of the steel sheet corresponding to the inner face of the steel pipe;

a steel pipe forming part for obtaining a continuous steel pipe by continuously cold-forming the steel sheet subjected to the inner-face plating into a tubular shape and seam-welding a longitudinal end face joint portion of the steel sheet formed in the steel pipe; and

an outer-face plating performing part that performs molten metal-plating by dipping the outer face of the steel pipe into molten metal,

in which the inner-face plating performing part and/or the outer-face plating performing part include the plating bath and the heating device to heat the plating bath;

in which the inner-face plating performing part includes:

a pouring part that pours molten metal to the upper side of the steel sheet,

a molten metal supply part that can supply molten metal to the pouring part, and

an inner-face wiping part that removes molten metal poured by the pouring part,

in which the pouring part has a movable means that is movable in parallel to a direction where the steel sheet advances,

a relative distance between an initial molten metal pouring position and a position of the inner-face wiping part is adjustable, and

the outer-face plating performing part includes:

a dipping part that has space for allowing the continuous steel pipe to pass therethrough and allows the outer face of the continuous steel pipe to be dipped into molten metal when molten metal is introduced into the space,

a molten metal supply part that can supply the molten metal to the dipping part, and

an outer-face wiping part that removes surplus metal from the continuous steel pipe dipped into the molten metal by the dipping part,

in which the dipping part has a movable means that is movable in parallel to a direction where the steel sheet advances,

a relative distance between an initial molten metal dipping position and a position of the outer-face wiping part is adjustable, and

the inner-face plating performing part and/or the outer-face plating performing part include the plating bath and the heating device to heat the plating bath.

A position of the inner-face wiping part and/or the outer-face wiping part may be movable.

A position of the inner-face wiping part and/or the outer-face wiping part may be fixed.

The outer-face plating performing part may include

a plurality of dipping parts continuously arranged in a direction where the continuous steel pipe advances, and the molten metal supply part is, on the supply, able to change the number of the dipping part(s) where molten metal is to be supplied.

The outer-face wiping part may be installed immediately after each of the plurality of dipping parts, and

which can determine that any wiping part(s) of the plurality of wiping parts is (are) to be operated.

The outer-face wiping part installed between the dipping parts may be an open circular and movable type wiping part which includes an annular portion surrounding the continuous steel pipe and a plurality of gas ejecting holes formed inside the annular portion and in which the annular portion is ring-opened and movable to a position distant from the continuous steel pipe.

In addition, the present invention may be a method for producing a plated steel pipe using any one of the systems.

Here, the variation in temperature in the plating bath of the molten metal plating furnace may be not greater than 20 degrees.

Furthermore, the present invention may be a steel pipe obtained by any one of the methods for producing a plated steel pipe, in which the thickness of a plated layer 4 μm or less.

According to the present molten metal plating furnace, it is not a heating system that flame is emitted into a space between an iron pot and a molten metal bath for heating by heat conduction as in the conventional burner, namely, the heating system employed is that molecules generated by combustion of fuel or the like are injected so as apply kinetic energy, and the molecules storing the kinetic energy collide and vibrate so as to convert the kinetic energy to thermal energy for heating. Therefore, transfer speed of the heating system is higher than that of the heat conduction and the controlled temperature becomes easy to be controlled in a wide range. Additionally, as molten metal can be heated uniformly, a uniform plating quality can be realized. Furthermore, as heating by the direct flame of the burner is not performed, dross is hardly formed inside the metal plating bath, and rust hardly occurs. Further, also in a metal plating system into which the molten metal plating furnace (for example, a plating bath as a molten metal storage portion and a heating device to heat the plating bath) is incorporated, production capacity can be improved and higher quality of metal-plated products can be achieved due to the above effect.

### BRIEF DESCRIPTION OF DRAWINGS

FIGS. 1A to 1C are schematic views illustrating an embodiment of a molten metal plating furnace of the present invention, FIG. 1A is a plan view thereof, FIG. 1B is a cross-sectional view of the front (seen from the front side toward the rear side) along the cutting line I(b) to I(b) in FIG. 1A, and FIG. 1C is a cross-sectional view of the right side along the cutting line I(c) to I(c) in FIG. 1A;

FIG. 2 is a schematic perspective view illustrating an embodiment of the heating device (combustor) applied to the molten metal plating furnace of the present invention;

FIG. 3 is a cross section illustrating the combustor of FIG. 2 in end elevation in the direction of arrow B in FIG. 2;

FIG. 4 is a side view illustrating the combustor of FIG. 2 in sectioned side elevation along section line A-A in FIG. 2;

FIG. 5 is a cross section diagrammatically illustrating the another embodiment of the combustor in sectioned side elevation;

FIG. 6 is a cross section diagrammatically illustrating the combustor of FIG. 5 in rear view;

FIG. 7 shows a typical medium charging and covering means orifice array formed through the walls of a combustion chamber of the combustor and the adjusting mechanism used for adjusting the charging of combustion medium to the combustion chamber;

FIG. 8 is a schematic plan view illustrating the molten metal plating furnace used in an example;

FIG. 9 is a schematic plan view illustrating the molten metal plating furnace used in a comparative example;

FIGS. 10A and 10B are graphs illustrating measurement results of temperature distribution, FIG. 10A is a graph illustrating a measurement result of the example, and FIG. 10B is a graph illustrating a measurement result of the comparative example;

FIG. 11 includes Photos 1 to 4 showing a cross section of a zinc plated product; and

FIGS. 12A to 12C are schematic views illustrating a conventional molten metal plating furnace, FIG. 12A is a plan view thereof, FIG. 12B is a cross-sectional view of the front along the cutting line II(b) to II(b) in FIG. 12A, and FIG. 12C is a cross-sectional view of the right side along the cutting line II(c) to II(c) in FIG. 12A.

FIG. 13 is a schematic configuration diagram illustrating a molten metal-plating steel pipe manufacturing system according to the embodiment.

FIG. 14 is a schematic configuration diagram illustrating an inner-face molten metal-plating device according to the embodiment.

FIG. 15 is a schematic configuration diagram illustrating a pouring part of the inner-face molten metal-plating device according to the embodiment.

FIG. 16 is a schematic configuration diagram illustrating a movable part of the inner-face molten metal-plating device according to the embodiment.

FIG. 17 is a schematic configuration diagram illustrating an outer-face molten metal-plating device according to the embodiment.

FIG. 18 is a diagram illustrating a shape of a steel pipe and a dipping part of the outer-face molten metal-plating device.

FIG. 19 is a diagram illustrating a schematic configuration of a movable open circular type wiping part.

FIG. 20 is a diagram illustrating a relation between a plating speed and a dipping length of molten metal.

### DETAILED DESCRIPTION

The present invention will be specifically described hereinafter. Note that the present invention is not limited to these embodiments. A molten metal plating furnace according to the present invention will be described in detail and then, a metal plating system (system for producing a metal-plated product) into which the molten metal plating furnace is incorporated will be described in detail.

The molten metal plating furnace of the present invention has at least a molten metal plating bath surrounded by an inner wall, a heat-resistant outer wall, a heating chamber surrounded by the inner wall and the heat-resistant outer wall, and a heat source (heating device).

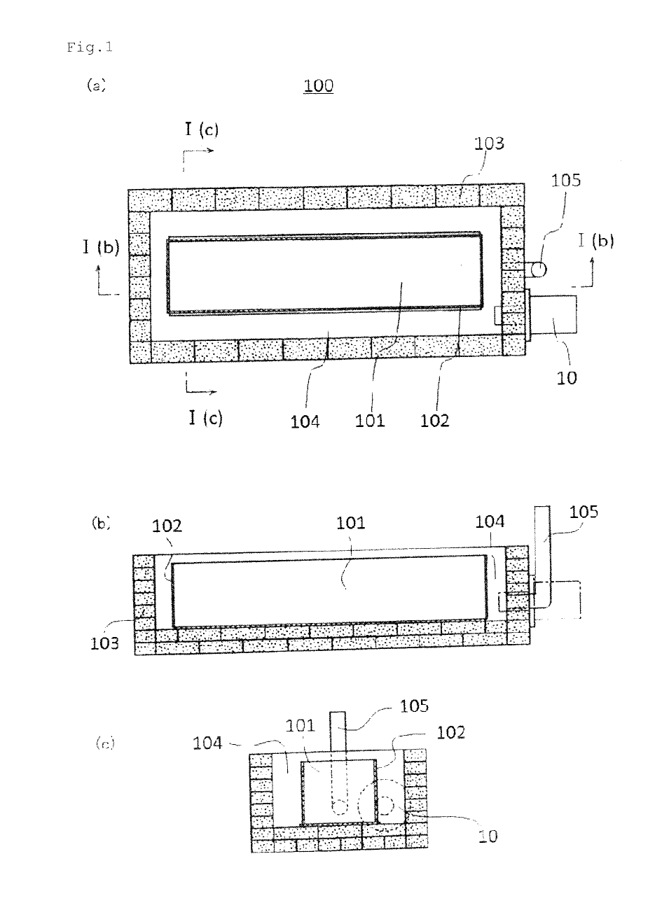

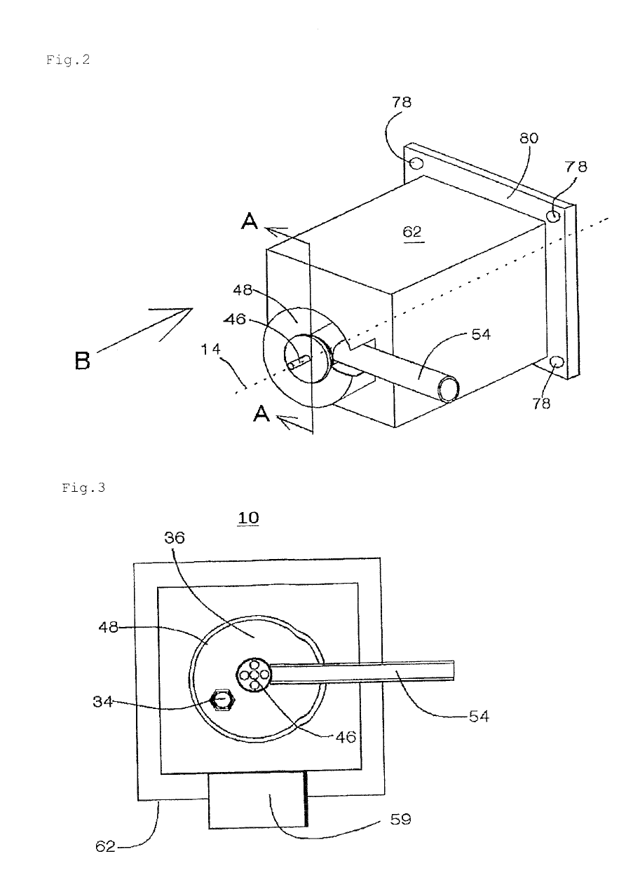

FIG. 1A is a plan view illustrating an outline of an embodiment of the molten metal plating furnace of the present invention. Inside a molten metal plating furnace 100, a plating bath 101 for storing molten metal is installed, and a heat-resistant outer wall 103 in a substantially rectangular shape composed of a short wall portion and a long wall portion is provided outside the same. Note that among the wall surfaces of the plating bath 101, a wall surface of the outer circumference of the plating bath is defined as an inner wall 102. The space between the heat-resistant outer wall 103 and the inner wall 102 is a heating chamber 104 for heating the plating bath 101. Further, near one end of the short wall portion of the heat-resistant outer wall 103, a heating device 10 is arranged so as to supply thermal energy to the heating chamber 104. Note that, here, an exhaust port 105 for exhausting a part of gas circulated in the heating chamber 104 is provided near the center of the short wall portion. Furthermore, although not illustrated, a lid member is attachably constituted on the upper portion of the molten metal plating furnace 100. This lid member is a member which insulates a system inside the metal plating furnace 100 from a system outside the metal plating furnace 100 when heating the furnace so as to make fluid communication from inside to outside of the metal plating furnace 100 impossible. Additionally, in order to make fluid communication between the heating chamber 104 and the inside of the plating bath 101 impossible, it is constituted so as to cover the molten metal plating furnace 100 (the heat-resistant outer wall 103 and the plating bath 101). (Namely, it is constituted so that gas or the like taken out of the heating device 10 can circulate inside the heating chamber 104 without intruding into the plating bath 101.)

Although an iron pot or the like is used as a plating bath, its material or the like does not need to be particularly limited. Material of a plating bath is preferably selected properly according to relation to kinds of molten metal offered to metal plating or the like. Note that kinds of molten metal offered to plating also can be selected properly.

The heating device (combustor) 10 used for the present invention will be described hereinafter. The heating device 10 is preferably a variable orifice combustor in a form of a combustor unit.

The combustor 10 comprises a combustion chamber 12 extending regularly about a central axis 14 and ending in a progressively constricted combusted medium discharge in the form a discharge nozzle 16 while charging of the chamber 12 takes place from combustion fuel and air supply dispositions in the form of an air charging chamber 18 and a fuel charging chamber 20 via combustion medium orifice arrays in the form of a fuel charging orifice array 22 and an air charging orifice array 24 formed in facing longitudinal walls 26 of the chamber and of which arrays 22, 24 the cross sectional sizes of the orifices 28 are adjustable by means of an adjustment mechanism including displaceably mounted orifice covering means 30 being formed with covering means orifice arrays 32 in number and size matching those of the relevant medium orifice array 22, 24 that they adjustably co-act with. As the size of the medium charging orifices 28 are mechanically adjustable via the covering means 30 the upstream supply of medium is not critical enabling the use of the unit 10 through a range of medium supply pressures. The chamber 12 is exposed to igniting means in the form of a spark plug 34 fitted through its real wall 36. The nozzle 16 can typically converge at an angle of 21 degrees.

The individual orifices 28.1 of the fuel charging orifice array 22 and the orifices 28.2 of the air charging orifice array 24 are positioned and slanted at the same forward angle in the direction of the nozzle 16 to the effect of the central axes 38 of the fuel charging orifices 28.1 crossing the central axes 40 of corresponding air charging orifices 28.2 along the longitudinal centre 42 of the combustion chamber 12. The orifices of the orifice arrays 32 also follow the direction of the orifices 28.1 and 28.2 resulting in charging taking place along the relevant axes 38 and 40 as also passing along the orifices of the orifice arrays 32 once the unit 10 is in use. The orifices 28 are suitably regularly arranged in rows and columns, as shown in FIG. 7 for a planarly extending array, and inter-spaced to promote a uniform pressure within the combustion chamber 12 once in use hence ensuring a steady isentropic transformation throughout the chamber 12. The orifice layout also promotes a more efficient combustion reaction owing to the longitudinal orifice spacing being selected to result in overlapping zones of combustion extending about the longitudinal centre 14 of the combustion chamber 12.

The orifices 28.1 of the fuel charging orifice array 22 and its adjustably registerable cover means orifices arrays 32 are conventionally smaller that the orifices 28.2 of the air charging orifice array 24 and its adjustably registerable cover means orifices arrays 32 owing to the volume of air required in a combustion reaction being larger than that of the fuel, whether gas, vapour or liquid.

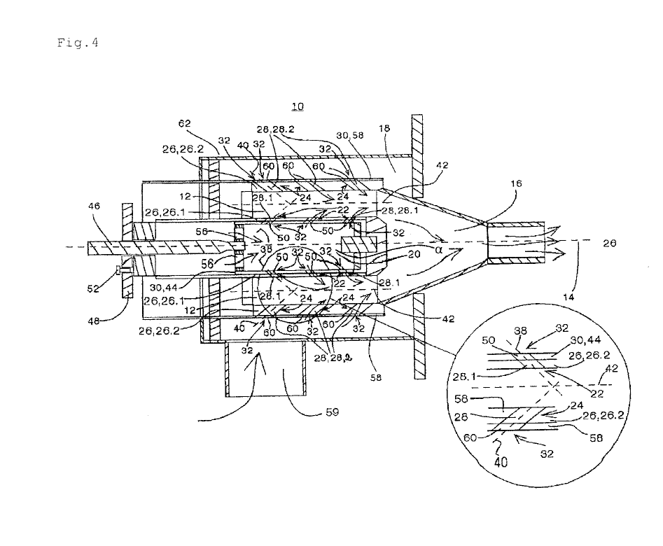

In referring to FIGS. 2 to 4 and in one embodiment the combustion chamber 12 is annularly formed while the fuel charging chamber 20 extends there within. The air charging chamber 18 annularly encompasses the combustion chamber 12.

The orifice covering means 30 is in the case of the fuel charging side in the form of an orifice cylindrically shaped covering body 44 fitted along the inner zone formed adjacent the inside wall 26.1 of the combustion chamber 12. The body 44 is slidably displaceable in the direction of the central axis 14 via a threaded shaft 46 via a fitted threaded shaft passing screw fashion along a manually rotatable adjustment wheel 48. Linear displacement of the body 44 has the effect of adjustment of the sizes of the fuel charging orifices 28.1 on the fuel side adjustment cylinder formed orifices 50 to a larger or lesser extent registering with the fuel charging orifices 28.1. The wheel 48 is fitted with a locking screw 52 via which it is locked against rotation thus locking the orifices 28.1 and 50 in a fixed relationship. Fuel is charged to the fuel charging chamber 20 via a supply conduit 54 and circumferentially spaced inlet apertures 56 opening up in the chamber 20.

On the air charging side the orifice covering means 30 is in the form of a combustion chamber outside cylindrical body 58 formed situated adjacent the outside wall 26.2 of the combustion chamber with the air side adjustment cylinder formed orifices 60. The body 58 is linearly displaceable in the direction of the axis 14 by its pushing or pulling by means of an independent tool. The air charging chamber 18 is supplied via an air feed supply 59.

The cylindrical body 44 fitted with its shaft 46 running along the wheel 48 and the cylindrical body 58 as appropriately adjustable form the orifice adjustment mechanism this embodiment of the invention.

The unit 10 is conventionally fitted with appropriate seals to limit the loss charging medium to the environment. The unit 10 of this embodiment is naturally enclosed within a housing 62.

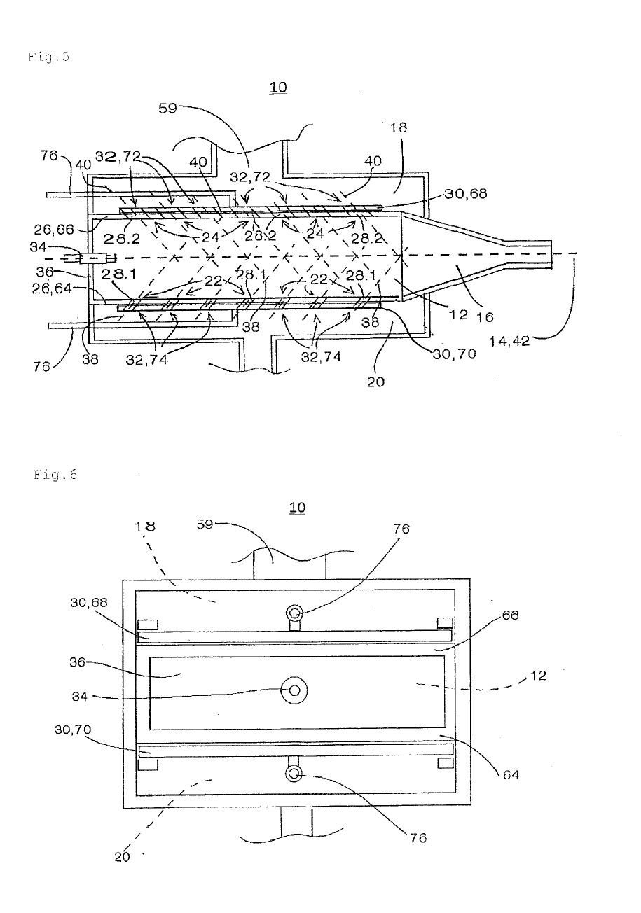

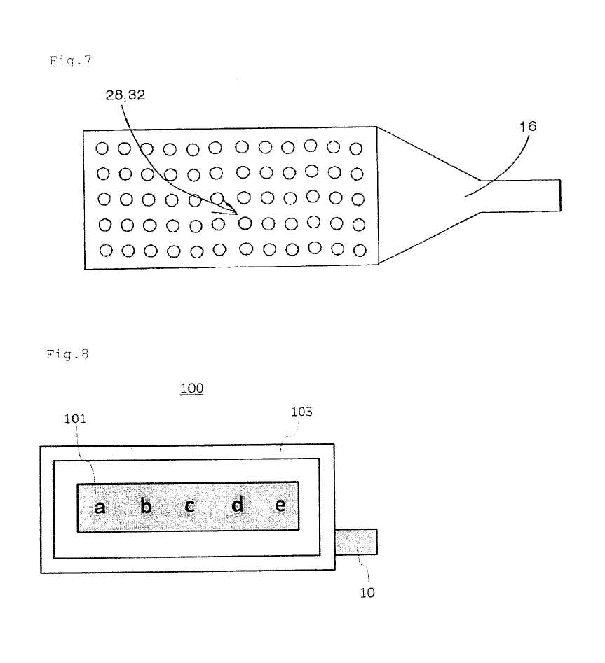

In another embodiment and referring to FIGS. 5 and 6 the combustion chamber 12 is in the form of a rectangular zone arranged to extend about the central axis 14 of the unit 10 that also forms the centre of the chamber 12. Opposite side walls 64 and 66 are respectively formed with the fuel charging orifice array 22 and the air charging orifice array 24.

The orifice covering means 30 is in the form of slidably mounted orifice plates 68 and 70 respectively being formed with the air charging side adjustment orifice array 72 and the fuel charging side adjustment orifice array 74 forming the covering means orifice arrays 32. The plates 68, 70 are mounted to being linearly displaced in the direction of axis 14 by way of handles 76. The plates 68 and 70 with their handles 76 form the adjustment mechanism of this embodiment.

While not shown the unit 10 of the FIGS. 5 and 6 embodiment is naturally also enclosed in a housing.

As the unit 10 runs at high temperatures it is conventionally manufactured from heat resistant material including stainless heat resistant steel alloys or the like.

While the combustor in the form of a unit 10, it is easily manufactured to directly replace conventional units by retrofitting. As shown in FIG. 2 it is thus simply boltable to the metal plating furnace 100 via apertures 78 in a front flange 80.

Once operatively installed and burning in response to the initial charge being ignited by the spark plug 34 the heating effect of the unit 10 is adjustable by simply adjusting the appropriate covering means orifice array 32, whether by way of the wheel 48 or the appropriate plate 70 for the fuel side charging or the cylindrical body 58 or the plate 68 for the air side charging.

Owing to the acceleration of the stream of combusted gases though the nozzle 16 heat loss from the combustion reaction to the location of heat application is curtailed enabling obtaining a desired temperature at a lower combustion temperature. The sidewall formed orifices and their way of arrangement has the effect of concentrating the combustion reaction towards the centre of the combustion chamber thus improving the efficiency of the reaction while the charging of appropriate medium is easily controlled by the alteration of the cross sectional areas of the medium charging orifices thereby also easily accommodating a change the supply pressure of combustion medium.

It is an advantage of the combustor unit 10 as specifically described that the charging of medium to the combustion chamber is easily controllable while the configuration of the charging and adjustment orifices promotes the burning efficiency of charged medium. Another advantage is found in the acceleration of combusted gases via the nozzle to limit a loss of heat between the combustor and its heating target.

Combustion gas and air taken into this heating device unit 10 are burned in a staged control system, and in each stage, theoretical mixture ratio in the heating device unit 10 is accurately maintained, thereby enabling complete combustion of the combustion gas, further achieving low temperature combustion. Accordingly, combustion gas molecules taken out of the heating device unit 10 can suppress thermal energy low while they become high-velocity gas molecule flow with high kinetic energy.

Although a case of a single heat source (heating device) is illustrated in FIG. 1, more than two heat sources can be installed according to the need. Note that the present invention employs a heating method of a new technology in which combustion gas molecules jetted from the heating device are low in temperature but high in velocity containing high kinetic energy. Therefore, convection in one direction in the heating chamber can be made possible by only a single heating device. Further, as the molten metal plating bath is heated by thermal energy converted by the molecules storing kinetic energy colliding with the inner wall or the like of the heating chamber which is an object to be heated and vibrating, temperature of not only the plating bath but inside the molten metal plating furnace can be uniform.

As the heating device employing such a heating method, namely, the heating device employing the heating system in which molecules are injected utilizing combustion of substances and kinetic energy is converted to thermal energy by molecules which store the kinetic energy colliding and vibrating for heating, for example, TKEnergizer (registered trademark) made by Tkenergizer Global Limited can be mentioned.

The molten metal plating furnace of the present invention uses the heating device of the heating system described above as heat source (heating device). Namely, this molten metal plating furnace uses the heating device in which molecules (e.g., CO₂ molecules, H₂O molecules) generated by fuel (e.g., gas hydrogen carbonate) combustion are injected into the heating chamber between the inner wall and the heat-resistant outer wall, and the molecules storing kinetic energy collide and vibrate so as to be converted to thermal energy. As heating of such a heating device utilizes molecule vibration, its transfer speed is faster than heat conduction. For example, the transfer speed in the case of the present invention in which molecules are discharged continuously at high speed so as to collide with an object to be heated, and the molecule kinetic energy is converted to vibration so as to be transferred to the interior and converted to thermal energy becomes about three times as fast as the transfer speed of a regular gas burner or the like which makes heat penetrate into the interior of an object to be heated from its surface by heat conduction.

Additionally, in the present invention, conversion to thermal energy is performed; therefore temperature control generally according to a required controlled temperature is enabled. When a sealed space (furnace) is filled with molecules storing kinetic energy, initial collision vibration energy is converted to thermal energy and temperature in the furnace rapidly becomes uniform including an object to be heated (e.g., bath). Further, as the collision vibration energy is successively added, the temperature in the furnace rapidly increases up to a set temperature being capable of realizing uniform heating in the furnace. Accordingly, a metal plating furnace including such a heating device can suppress occurrence of dross, achieve a prolonged lifetime of a pot (plating bath) and suppress variation in temperature of molten metal in a plating bath so as to perform uniform plating and improve plating quality.

In the heating device by the heating system of the present invention, as the fuel is combusted completely inside the heating device and injected as molecule kinetic energy, the temperature of the discharge port of the device can be considerably lower than that of a regular gas burner or the like, for example, may be lower than the level of temperature in the furnace. Additionally, in a high-velocity burner used as a means of heating the conventional metal plating furnace, the fuel is combusted not inside but outside the burner and injected as flame from the discharge port of the burner. Namely, a heating system thereof is completely different from that of the present invention in which the fuel is completely combusted inside the device. Moreover, by the conventional high-velocity burner, the temperature becomes that of flame, consequently the temperature becoming extremely high compared to the temperature of the heating device of the present invention. This temperature difference at the discharge port significantly influences the loss of combustion gas, and the heat efficiency can be dramatically improved by the heating method of the present invention. More specifically, according to the heating system of the present invention, the molecules themselves filling the heating chamber are low in temperature as well as being converted to heat for the first time when colliding with an object to be heated (e.g., plating bath); therefore, the atmosphere temperature of the heating chamber is not increased more than necessary. Accordingly, it becomes possible to restrain the loss of combustion gas (heat energy exhausted as high-temperature gas) at the exhaust port compared to the case of using a regular burner, thereby enabling the gas consumption amount to decrease.

Additionally, according to the present invention, uniform and rapid heating and heat penetration to the whole object to be heated (plating bath) can be realized, consequently, heat treatment time can be drastically shortened and process time for one heating work can also be shortened. Therefore, along with the dramatic improvement in heat efficiency, the molten metal plating furnace of the present invention can reduce the gas consumption amount by about 40% to 80% compared to the molten metal plating furnace including a heating device such as the conventional gas burner, consequently, production capacity can be enhanced drastically.

Moreover, according to the present invention, the temperature does not need to be heated above the temperature in the furnace, and regular operations at the temperature of the same level as the temperature in the furnace are possible, thereby enabling variation in temperature of molten metal to be suppressed through uniform heating to the whole plating bath (pot) and uniform heat penetration into a deep portion (in the present invention, the variation in temperature of the plating bath can be not greater than 20 degrees). Accordingly, also machining quality can be improved without occurrence of distortion of processed goods and surface crack. Further, in the present invention, the variation in temperature in the plating bath is as shown in following Example. Specifically, when the reference point of temperature of the molten metal temperature at the substantially center of the bath is provided and the temperature at the reference point of temperature (controlled temperature) is controlled at substantially constant temperature, the variation in temperature in the plating bath means the difference between the maximum temperature and the minimum temperature of the molten metal temperatures measured at various places (temperature variation measuring points) in the bath. The controlled temperature is at least higher than a melting temperature of a metal material for plating, and is preferably a temperature generally applied at a molten metal plating method, for example, temperature of not less than the melting temperature of the metal material for plating plus 20 degrees but not an excessive temperature (e.g. a temperature within the parameters of 440 to 460 degrees for molten zinc plating). In addition, various places (temperature variation measuring points) mean, for example, each places of the sections into which the bath divided equally (at least in five equal parts) in the longitudinal direction (preferably the center portions of the each equally divided sections). Also, in regard to the measurement of the molten metal temperature, a measured value of successively varying temperature, at a time when metal is molten for fixed time (e.g. 10 to 30 minutes), shall be referred. Furthermore, the present invention uses hydrogen carbonate gas, for example, as energy fuel, and combusts the same completely while keeping stability of air and gas, and is capable of controlling not to be a high temperature, so that occurrence of CO and NOₓ or the like can be suppressed so as to enable an environmental load to be reduced.

The molten metal plating furnace according to the present invention can properly be incorporated into a system for producing a publicly known metal-plated product having a plating performing part (unit) that performs plating on a plated object. When the molten metal plating furnace according to the present invention is incorporated into a system for producing a publicly known metal-plated product, only a plating bath as a molten metal storage portion and a heating device as a heat source may be incorporated as needed.

Next, a system for producing a metal-plated steel pipe will be described as a suitable example of the system for producing a metal-plated product into which the molten metal plating furnace according to the present invention is incorporated.

The system of a metal-plated steel pipe into which the molten metal plating furnace according to the present invention is incorporated is not particularly limited and the molten metal plating furnace may properly be incorporated into a facility (plating performing unit) that performs plating on a steel pipe (steel plate) in any form. More specifically, the molten metal plating furnace (for example, a plating bath and a heating device to heat the plating bath) according to the present invention may be incorporated into the plating performing part of a system of a publicly known metal-plated steel pipe as a facility (metal melting part) to melt metal for plating or a facility (molten metal storage portion) to store molten metal. For example, in a metal-plated steel pipe system that performs metal plating by dipping a steel pipe into molten metal, the molten metal plating furnace (for example, a plating bath and a heating device to heat the plating bath) according to the present invention may be employed as an alternative to the dipping facility. Also in a metal-plated steel pipe system (for example, a metal-plated steel pipe system shown in JP H5-148607 A or the like) that performs metal plating by pouring a molten metal plating solution onto a steel pipe, the molten metal plating furnace (for example, a plating bath and a heating device to heat the plating bath) according to the present invention may be employed as an alternative to the molten metal plating bath (molten metal storage portion).

In a system for producing a metal-plated steel pipe, by incorporating the molten metal plating furnace (molten metal furnace) according to the present invention, the following effect regarding the effect of the aforementioned molten metal plating furnace can be obtained.

A heating device 10 in the present embodiment can melt metal efficiently by a heating method (specific heating method capable of converting kinetic energy generated by combustion and held by combustion gas molecules into thermal energy by collision and vibration) that is different from a conventional method and can also be replaced by an existing heating device and therefore, productivity of metal-plated steel pipes can be improved without needing large modifications and investment in existing equipment having a similar configuration of the molten metal plating furnace.

Further, as described above, the life of a pot (bath) in the molten metal plating furnace can be prolonged and therefore, various kinds of cost (cost of facilities and the like) can be reduced.

In addition, the space of the facility related to the molten metal plating furnace can be saved. More specifically, when a plated layer is formed by dipping a steel pipe (steel plate) into molten metal of the molten metal plating furnace (inside the molten metal bath), the furnace (bath) needs a certain size to prevent the temperature of the molten metal from falling extremely due to the passing steel pipe (steel plate) inside the bath. Also when a plated layer is formed by scooping up molten metal from the molten metal plating furnace (molten metal storage portion) and pouring the molten metal, the furnace (bath) needs to have a certain size to store a sufficient amount of molten metal. However, as a result of being able to achieve quick heating by using the specific heating method, the facility itself of the furnace can be reduced by preventing the temperature of the molten metal from falling extremely and therefore, the system (facilities) for producing the metal-plated steel pipe as a whole can be reduced in size.

According to the molten metal furnace in the present invention, as described above, the temperature range of the molten metal can finely be controlled and thus, if metals to be plated are different types of metals (for example, when two metals are plated like in JP 2011-528569), the temperature can also be controlled easily. More specifically, if, for example, optimal ranges of the two metals overlap to a certain degree (if the difference of melting points of the two metals are not too large), the molten metal can easily be heated to a temperature in the overlapped range and thus, plating using the two metals can be performed. According to a conventional heating method, on the other hand, when two metals are heated and melted in the same furnace, the temperature range inside the furnace varies and thus, when the furnace temperature is set to the desirable temperature range of one metal, the other metal is outside the desirable temperature range.

As described above, the molten metal plating furnace according to the present invention can also be incorporated into a system that performs molding of a steel pipe (cold molding from band steel to a tubular shape), welding, and molten metal plating by a continuous line (production line of a metal-plated steel pipe as shown in, for example, JP H5-148607 A). When the molten metal plating furnace according to the present invention is incorporated into such a system, metal can efficiently be melted and thus, when a large quantity of steel pipe is treated, the temperature of molten metal in the furnace (bath) can be prevented from falling extremely (thus, a situation in which the line is slowed down to raise the temperature of the molten metal to an appropriate temperature is less likely to arise). More specifically, in a continuous producing process including a plurality of facilities, the facility of the slowest production capacity can determine the limit of the production capacity (as an example, the speed of a cutter, the capacitance of a facility, heating performance of a plating furnace and the like can be rate controlling). Among others, in the plating furnace, with an increasing number of steel pipes (steel plates) passing in the furnace, the temperature of the molten metal in the furnace decreases and the speed of the line cannot be increased. However, by introducing the molten metal plating furnace according to the present invention, heating efficiency (rate of temperature rise) is enhanced and the temperature thereof is less likely to fall even if a large number of steel pipes (steel plates) pass in the furnace (bath) so that the production (production capacity) of plated steel pipes of the whole system can be improved.

Next, as a system for producing a metal-plated steel pipe into which the molten metal furnace according to the present invention can be incorporated, a specific system and method for producing a steel pipe on a continuous line will be described in detail, but the present example is only an example and the present invention is not limited to such an example. The molten metal furnace (particularly, the plating bath and the heating device to heat the plating bath) used concretely in the present producing system is as described above and thus, the description thereof is omitted here.

Hitherto, as one of representative methods of performing molten metal-plating on a steel pipe, there is a known hot-dipping method. Further, in recent years, a method of manufacturing a molten metal-plated steel pipe in a continuous steel pipe manufacturing line has been proposed from the viewpoint of a decrease in the cost. As one of the methods, for example, JP S52-43454 B discloses a technique of manufacturing an outer-face plated steel pipe in a manner such that a steel sheet is continuously cold-formed into a tubular shape and the result is welded and is plated with molten metal. Furthermore, there is a growing need to perform an inner-face metal plating in recent years. Therefore, for example, JP H05-148607 A discloses a method of easily plating both inner and outer faces of a steel pipe with molten metal in a continuous line in a manner such that one face in a steel sheet corresponding to the inner face of the steel pipe is subjected to plating in a steel pipe manufacturing line, the result is cold-formed into a tubular shape, a longitudinal end face of the steel sheet is welded, and the outer face of the steel pipe is subjected to molten metal-plating.

Various specifications are required in the steel pipe which is manufactured in the continuous line. That is, the diameter of the steel pipe and characteristics such as corrosion resistance thereof need to be changed depending on the requirements of the consumers. Thus, in the continuous line, a steel pipe according to one specification is manufactured, and thereafter a steel pipe according to another specification is manufactured. However, at this time, there is a need to adjust a molten metal dipping time in the plating. In the case of the general dipping plating, only the molten metal dipping time may be adjusted. However, in the plating of the continuous line, the line speed needs to be changed in order to adjust the dipping time, which affects the manufacturing efficiency and so on.

Further, in the continuous line, the line needs to be stopped or the line speed needs to be decreased when any trouble occurs. When the line is temporarily stopped and restarted in order to perform plating in the continuous line, since the plating is performed after the pretreatment, an unplated portion may be generated in the length necessary for the spent time, which leads to an increase in the coat. Thus, the line speed may be decreased so that the continuous line does not stop. However, when the line speed is decreased in this way, the molten metal dipping time is extended at the time of processing the manufactured plated steel pipe, thereby causing a problem in that the plating is cracked or peeled.

The inventors of the present invention found that work efficiency and plating quality can further be improved by incorporating a molten metal plating furnace according to the present invention in a method and a system for producing a metal-plated steel pipe capable of making a plating dipping time constant by adjusting to changes of the line speed without stopping the line regarding the method for producing a steel pipe on a continuous line capable of easily adjusting the dipping time as a continuous steel pipe production line capable of solving the above problems.

The detail of the steel pipe plating system in the present embodiment is as below.

According to the embodiment (1), there is provided a steel pipe manufacturing system that manufactures a steel pipe, of which inner and outer faces or any one face thereof is subjected to molten metal-plating, from a steel sheet in a continuous manufacturing line, the system including: an inner-face plating performing part(unit) (for example, the inner-face molten metal-plating device A5) that performs molten metal-plating by pouring molten metal to the upper side of the steel sheet corresponding to the inner face of the steel pipe; a steel pipe forming part (for example, the forming device A7 and the welding device A8) for obtaining a continuous steel pipe by continuously cold-forming the steel sheet subjected to the inner-face plating into a tubular shape and seam-welding a longitudinal end face joint portion of the steel sheet formed in the steel pipe; and an outer-face plating performing part (for example, the outer-face molten metal-plating device A13) that performs molten metal-plating by dipping the outer face of the steel pipe into molten metal, in which a dipping length of molten metal is adjustable in the inner-face plating performing part and/or the outer-face plating performing part.

The embodiment (2) provides the system according to the embodiment (1), in which the inner-face plating performing part (for example, the inner-face molten metal-plating device A5) includes a pouring part (for example, the pouring part 501) that pours molten metal to the upper side of the steel sheet, a molten metal supply part (for example, the molten metal pump 550) that supplies molten metal to the pouring part, and an inner-face wiping part (for example, the inner-face wiping part 503) that removes molten metal poured by the pouring part, and in which the relative distance between the initial molten metal pouring position and the position of the inner-face wiping part is adjustable.

The embodiment (3) provides the system of the embodiment (2), in which the pouring part has a movable means (for example, the movable part 504) that is movable in parallel to a direction where the steel sheet advances.

The embodiment (4) provides the system according to any one of the embodiments (1) to (3), in which the position of the inner-face wiping part is fixed.

The embodiment (5) provides the system according to any one of the embodiments (1) to (4), in which the outer-face plating performing part includes a plurality of dipping parts (for example, the dipping parts 601) which have a space for allowing the continuous steel pipe to pass therethrough, allow the outer face of the continuous steel pipe to be dipped into molten metal when molten metal is introduced into the space, and are continuously arranged in a direction where the continuous steel pipe advances, an outer-face wiping part (for example, the wiping part 602) that removes surplus metal from the continuous steel pipe dipped into molten metal by the dipping part, and a molten metal supply part (for example, the molten metal pump 550) that can supply molten metal into the dipping part, in which the molten metal supply part is, on the supply, able to change the number of the dipping part(s) which molten metal is to be supplied.

The embodiment (6) provides the system according to the embodiment (5), in which the outer-face wiping part is installed immediately after each of the plurality of dipping parts, and which can determine that any wiping part(s) of the plurality of wiping parts is to be operated.

The embodiment (7) provides the system according to the embodiment (6), in which the outer-face wiping part(s) installed between the dipping parts is(are) a movable open circular type wiping part(s) (for example, the movable open circular type wiping part 602-1) which includes an annular portion (for example, the annular portion 60201) surrounding the continuous steel pipe and a plurality of gas ejecting holes (for example, gas ejecting holes 60202) formed inside the annular portion and in which the annular portion is ring-opened and movable to a position distant from the continuous steel pipe.

The system for producing a molten metal plated steel pipe in the present embodiment is a system including the plating performing part as a specific plating performing part (specified plating performing part) into which the molten metal plating furnace is incorporated. More specifically, in the system for producing a molten metal plated steel pipe in the present embodiment, the molten metal plating furnace is incorporated as a molten metal source (molten metal supply source of molten metal supplied to the molten metal pump 550) in the inner surface molten metal plating device A5 and further, the molten metal plating furnace is incorporated as a molten metal source (molten metal supply source of molten metal supplied to the molten metal pump 550) in the outer surface molten metal plating device A13 (the inner surface molten metal plating device A5, the outer surface molten metal plating device A13, and the molten metal pump 550 will be described below). In the present embodiment, as described above, the inner surface plating performing part (unit) and the outer surface implementation parts (units) are both specified plating performing parts (units), but the present embodiment is not limited to such an example and changes fitting to the system for producing a metal-plated steel pipe may properly be made such as using the specified plating performing part for one of the inner surface plating performing part and the outer surface plating performing part. Hereinafter, the system for producing a molten metal plated steel pipe in the present embodiment will be described in detail with reference to the drawings.

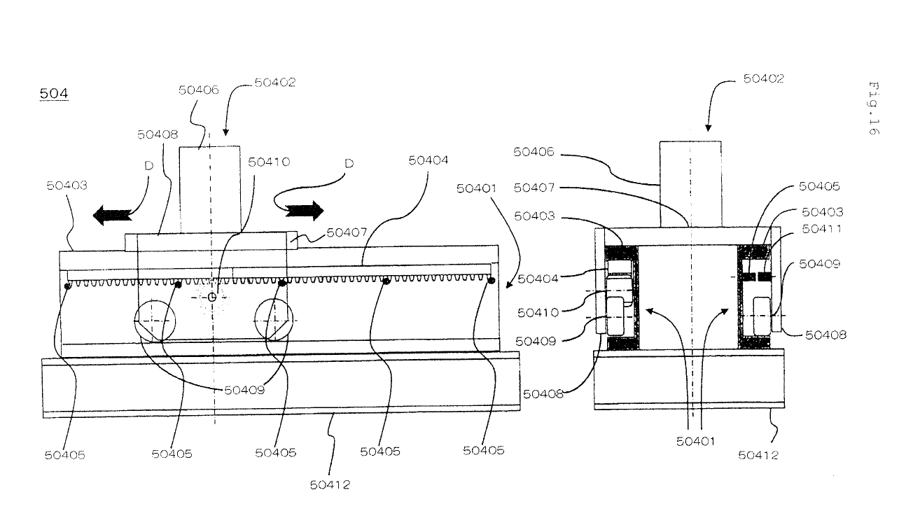

FIG. 13 is a schematic configuration diagram illustrating a manufacturing system of molten metal-plating steel pipe according to the embodiment. The manufacturing system includes: an uncoiler A2 which continuously supplies an elongated steel sheet wound around a coil A1; a forming device A7 which continuously forms the steel sheet supplied from the uncoiler A2 into a tubular shape; an inner-face molten metal-plating device A5 which allows a steel sheet to be molten metal-plated with desired metal immediately before the steel sheet is continuously formed in a tubular shape; a welding device A8 which forms a tubular body by continuously welding a longitudinal end face joint portion of the plated steel sheet formed in a tubular shape; a bead cutting device cutting device A10 which continuously cuts a welded bead portion formed on the outer face of the tubular body; an outer-face molten metal-plating device A13 which includes plural (for example, four) dipping parts and forms a molten metal-plated steel pipe by allowing the outer face of the tubular body to be continuously hot-dip plated; a sizing device A15 which forms a hot dip galvanized steel pipe into standard dimensions; and a cutting device A16 which cuts the hot dip galvanized steel pipe into a predetermined length.

If necessary, a shot blasting device A3, a pretreatment device A4 which performs an oxidization preventing flux liquid applying operation and a drying and preheating operation, a flux applying device A11 which continuously applies a flux liquid for cleaning the outer face of the tubular body and preventing the oxidization thereof, or a preheating device A12 which dries the outer face of the tubular body and preheats the tubular body may be provided. Depending on the property of plating metal, a first cooling trough (tank) A6 which cools the steel sheet after the molten metal-plating is performed thereon or a second cooling trough A14 which cools the tubular body after the molten metal-plating is performed thereon is provided. The cooling trough is essentially provided if the metal-plating is galvanizing.

In the present example, a method of applying flux to the surface of a steel plate and then drying and preheating the steel plate is adopted as pre-cleaning (cleaning of the surface of the steel plate) of the steel plate to be plated, but cleaning may also be done by any other publicly known method. For example, the publicly known method such as the Zendgimer method (a steel plate is heated in a direct fired oxidation furnace and after rolling oil adhering to the surface of the steel plate is burned, the steel plate is heat-annealed in a reducing zone under a hydrogen atmosphere and the surface of the steel plate that is slightly oxidized is reduced and cooled), the non-oxidation furnace method (method in which the oxidation furnace in the Zendgimer method is replaced by a non-oxidation furnace), and the U.S. Steel method (after rolling oil adhering to the surface of a steel plate is removed by an alkali electrolytic cleaning device, the steel plate is further subjected to acid cleaning) may be applied. Also, the steel plate may be pickled or cleaned with water in appropriate timing.

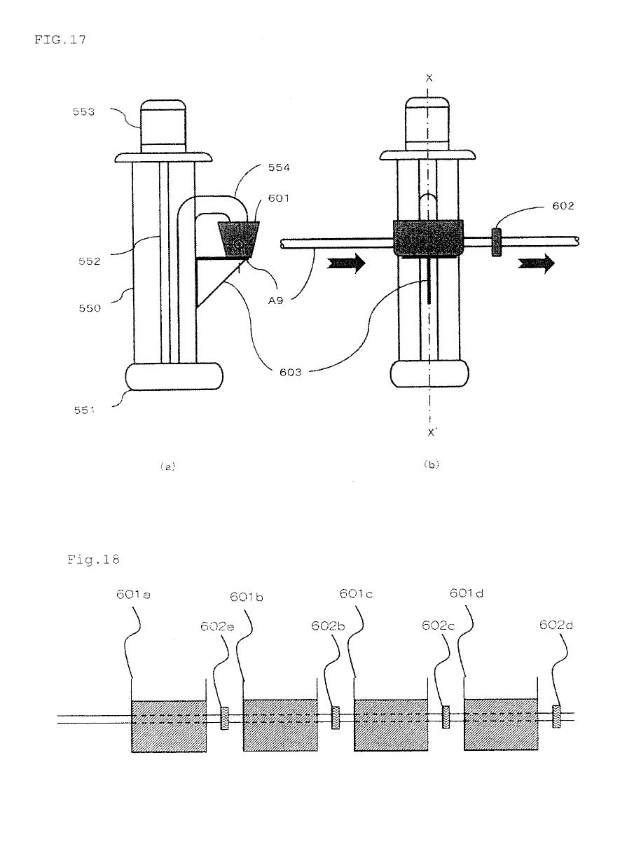

Next, the configuration of the inner-face molten metal-plating device A5 which is the characteristic point of the invention will be described. FIG. 14(a) is a schematic cross-sectional view taken along the line X-X′ of the inner-face molten metal-plating device A5 according to the embodiment, and FIG. 14(b) is a conceptual side view illustrating the inner-face molten metal-plating device A5. The inner-face molten metal-plating device A5 according to the embodiment includes: a molten metal pump 550 which supplies molten metal into a pouring part; a pouring part 501 which pours molten metal supplied from the molten metal pump to the steel sheet so as to perform a plating treatment thereon; a support part 502 which supports the rear face of the steel sheet so as to prevent the warpage of the steel sheet; an inner-face wiping part 503 (for example, a blowing-off device such as an inert gas or air wiper) which removes surplus molten metal from the pouring part; and a movable part 504 (a slide base frame) for enabling to adjust the relative positional relation between the pouring part and the wiping part. The structure of the movable part 504 will be described later in detail. Here, the molten metal pump 550 includes: an impeller casing 551 which accommodates an impeller for pumping molten metal; an impeller shaft 552 which transmits the rotational driving force of the pump motor to the impeller accommodated in the impeller casing; a pump motor 553 which serves as a power source for pumping molten metal; and a molten metal discharge port 554 which discharges molten metal sent from the impeller casing. Here, the detailed structure of the pouring part 501 will be described. As illustrated in the schematic diagram of FIG. 15, although it is not particularly limited, the pouring part 501 includes, for example, a container 501a and plural molten metal pouring holes 501b which are formed in the bottom portion thereof. Furthermore, here, a dipping length of molten metal means the distance from the pouring hole positioned at the most upstream side of the line to the wiping part 503. Here, the wiping part 503 may be movable, but may be appropriately fixed so as to maintain the distance from the position of the wiping part 503 to the cooling trough to be constant in a case where the cooling trough is needed particularly at the time of performing galvanizing.

As described above, the molten metal plating furnace 100 according to the present invention may be incorporated as a molten metal source (molten metal source of molten metal supplied to the molten metal pump 550) in the inner surface molten metal plating device A5.

FIG. 16 is a schematic diagram illustrating the movable part according to the embodiment. The movable part 504 includes a base frame 50401 and a pump main body base 50402. Furthermore, although it is not illustrated in the drawings, the pump main body base is connected to the pouring part 501, and when its portion moves, the pouring part may be moved and the dipping length of molten metal may be adjusted. The base frame includes: a pair of slide base frames 50403; a rack gear 50404 which is formed so as to be fittable to a pinion gear which will be described later and is installed in the substantially entire face of one of the slide base frames; and positioning sensors A50405 which are installed in at least one slide base frame with substantially the same interval therebetween. The pump main body base includes a pump main body 50406; a ceiling plate 50407; side plates 50408 which are formed at both sides of the ceiling plate; a guide roller 50409 which is installed at the two side plates so as to receive the weight of the pump and easily move the pump main body; a pinion gear 50410 which is formed so as to be fittable to the rack gear so as to perform a driving and positioning operation; and a positioning sensor B50411 which is installed in at least one of the side plates. Further, at the lower portion of the base frame, a base frame support body 50412 may be equipped. Due to the strong and reliable transmission without slip through the meshing between the pinion gear 50410 and the rack gear 50404 fixed to the slide base frame 50403, it is configured to be movable to the positioning sensors A50405 which are installed in a distance determined in advance. However, the moving method is not limited to the above-described method. For example, the moving distance may be set without the positioning sensor by using the number of rotations of the pinion gear through an electric motor and a speed changer, a servo motor or the like.

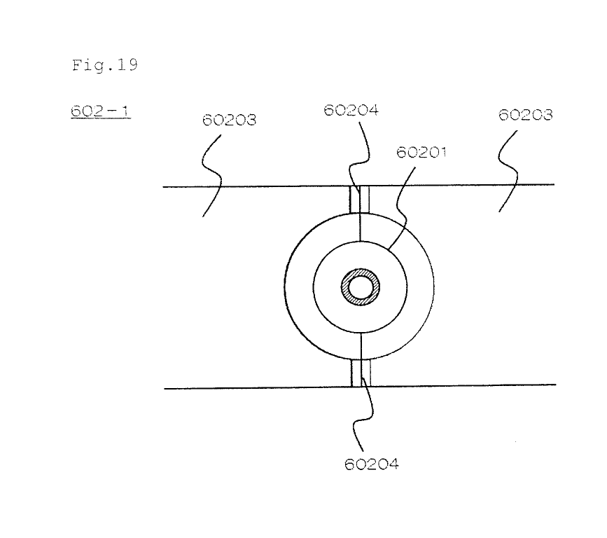

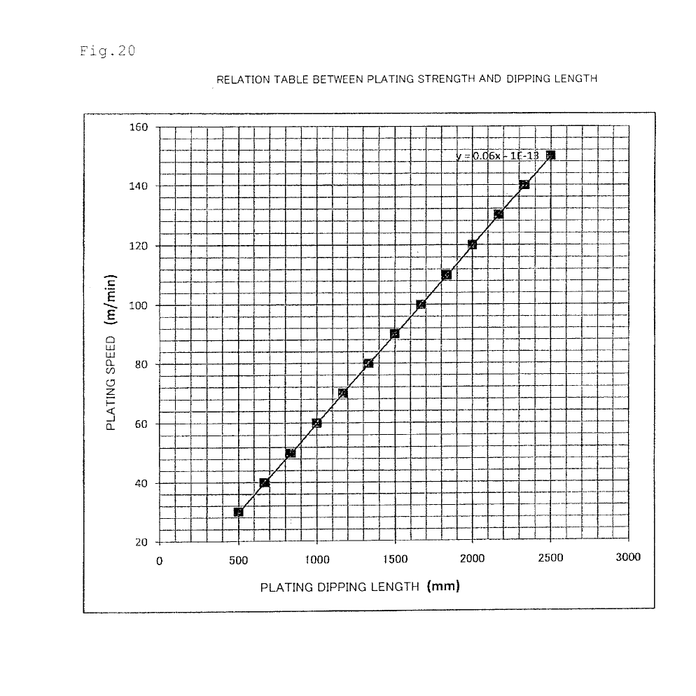

Next, the configuration of the outer-face molten metal-plating device A13 which is the characteristic point of the invention will be described. Here, the outer-face molten metal-plating device A13 includes plural (for example, four) parts illustrated in FIG. 17. FIG. 17(a) is a schematic cross-sectional view taken along the line X-X′ of one unit of the outer-face molten metal-plating device A13 according to the embodiment, and FIG. 17(b) is a conceptual side view illustrating one unit of the outer-face molten metal-plating device A13. The outer-face molten metal-plating device A13 includes: a molten metal pump 550 which supplies molten metal into a dipping part; a dipping part 601 which stores the molten metal supplied from the molten metal pump and allows the molten metal to pass through the steel pipe A9 so as to perform a molten metal-plating treatment thereon; and a wiping part 602 (for example, a blowing-off device such as an inert gas or air wiper) which removes surplus molten metal attached to the steel pipe at the time of performing the plating treatment by the dipping part. The wiping part will be described later in detail. Furthermore, the wiping part may further include a dipping part support 603 which supports the dipping part. Furthermore, since the configuration of the molten metal pump 550 is the same as that of the inner-face molten metal-plating device A5, the description thereof will not be repeated by giving the same reference numeral thereto. Here, FIG. 18 schematically illustrates the periphery of the steel pipe when these parts are arranged in the outer-face molten metal-plating device. Here, in the outer-face molten metal-plating device A13, the respective dipping parts 601 are continuously arranged in a direction where the steel pipe advances. Further, with regard to the distance from the exit to the entrance between the respective dipping parts, it is desirable to set the distance so that the steel pipe is continuously dipped in the molten metal flowing out of the exit and the entrance of the dipping parts. The wiping part 602 is provided at the downstream of each dipping part. It is desirable to configure the wiping parts so that only the wiping part(s) immediately after the dipping part(s) to which molten metal is supplied is(are) operated. This is because the wiping cools the steel pipe dipped in the molten metal and affects the quality of plating. Here, the wiping parts 602a to 602c which are provided between the dipping parts are movable ring-opening type wiping parts 602-1. FIG. 19 illustrates the configuration of the movable open circular type wiping part 602-1. The movable open circular type wiping part 602-1 includes: an annular portion 60201 which surrounds the outer periphery of the steel pipe; plural gas ejecting holes 60202 (not illustrated) which are formed inside the annular portion and blow a gas toward the steel pipe; and support bodies 60203 which support the annular portion. Here, the annular portion 60201 includes a notch 60204 which halves the annular portion, and when the support bodies are operated so as to be away from each other, the support bodies may be movable to a position distant from the steel pipe. With such a moving mechanism, since the wiping part may be movable to a position distant from the exit and the entrance of the dipping parts when the movable open circular type wiping part is not operated, the gas ejecting holes are not blocked by the molten zinc which flows out of the exit and the entrance. In this way, since there are plural outer-face molten metal dipping parts according to the invention, when the number of the dipping parts to which the molten metal is supplied is(are) adjusted, the thickness of the plated alloy layer of the outer face of the steel pipe may be equalized by adjusting the dipping length of the molten metal in accordance with a change in the line speed. Furthermore, the outer-face molten metal-plating device A13 may be used at the time of plating the same type of metal (for example, molten zinc). At the time of further plating (special plating) different metal, the different metal may be introduced into the dipping part(s). Further, in addition to the outer-face molten metal-plating device A13, another outer-face molten metal-plating device (with, for example, the same configuration) may be installed at the downstream of the outer-face molten metal-plating device A13.

As described above, the molten metal plating furnace 100 according to the present invention may be incorporated as a molten metal source (molten metal source of molten metal supplied to the molten metal pump 550) in the outer surface molten metal plating device A13.

Next, the manufacturing method of the invention using the above-described manufacturing line will be described. First, the steel sheet which is wound in a coil shape is continuously supplied from the uncoiler A2 toward the downstream side of the line. Next, a predetermined pretreatment is performed on the steel sheet by the shot blasting device A3 or the pretreatment device A4, and then an inner-face plating treatment is performed on one face of the supplied the steel sheet by the inner-face molten metal-plating device A5. The inner-face plating treatment will be described later in detail. Next, after the steel sheet of which one face was plated is cooled by the cooling trough A6, the steel sheet is introduced into the forming device A7 and is formed in a tubular shape by cold-forming. Then, the longitudinal end face joint portion of the steel sheet is continuously welded by the welding device A5, so that a continuous single tubular body A9 is formed.

Next, the tubular body A9 is supplied to the bead cutting device A10 equipped with a blade having a shape according to the outer face of the tubular body A9. Then, the welded bead portion which is formed on the outer face of the tubular body A9 is cut away by the blade of the bead cutting device A10, so that the outer face of the tubular body A9 becomes smooth.

Subsequently, the tubular body is sent to the flux applying device A11, so that the flux liquid for cleaning the outer face of the tubular body and preventing the oxidization thereof is applied thereon. The tubular body A9 is sent to the preheating device A12 so that residual heat is applied thereto, thereby drying the outer face.

Subsequently, the tubular body is sent to the outer-face molten metal-plating device A13. The tubular body A9 is dipped into the dipping part filled with pumped molten metal in the outer-face molten metal-plating device A13, so that the entire outer face is subjected to the molten metal-plating. The tubular body A9 which was dipped into the dipping part is provided with a molten metal-plated layer having a strong alloy layer, and the surplus molten metal-plating is removed in the wiping device 602, so that the molten metal-plated steel pipe is formed. Subsequently, it is cooled by the cooling trough A14. Furthermore, the outer-face molten metal-plating treatment will be described later in detail.

Then, the molten metal-plated steel pipe is subjected to cold rolling in the sizing device A15 so that the outer diameter is formed into a standard dimension. In the embodiment, the cold rolling is also needed so that the molten metal-plated layer has a comparatively uniform thickness in the circumferential direction. That is, even when the molten metal-plated layer immediately after formed by the outer-face molten metal-plating device has an irregular thickness in the circumferential direction, the molten metal-plated layer may be made to have a comparatively uniform thickness through the subsequent cold rolling or the like. In this way, in the embodiment, after the molten metal-plated layer is formed by the outer-face molten metal-plating device, for example, it is desirable to perform a sizing process such as cold rolling and perform a process which allows the molten metal-plated layer formed by the molten metal-plating treatment to have a comparatively uniform thickness (a process which equalizes the distribution of the thickness compared to the case immediately after the molten metal layer is formed).

The molten metal-plated steel pipe is cut into a predetermined length by the cutting device A16, so that a steel pipe product A17 is obtained.

Here, the inner-face plating treatment is a process in which surplus metal of the molten metal poured from the pouring part 501 of the inner-face molten metal-plating treatment device A5 to the steel sheet B is removed by the wiping part 503. Here, in the invention, a fact is examined in which the molten metal dipping time is proportional to the thickness of the formed alloy layer at the time of performing the molten metal-plating. However, the inner-face plating method which is used in the continuous line is performed according to the method in which molten metal is poured to the steel sheet from the upper side thereof. Here, although “dipping” as the general meaning is not performed, under a premise that the conditions, where the molten-metal is on the steel sheet by pouring, is “dipping”, the distance between the pouring part and the wiping part is adjusted as the dipping length of the molten metal. That is, even when the line speed is not changed, the thickness of the plated alloy layer may be adjusted by adjusting the molten metal dipping time in a manner such that the distance between the pouring part 501 and the wiping part 503 is changed. For example, when the line speed is temporarily decreased, the thickness of the plated alloy layer may be maintained so as to be uniform by adjusting the distance between the pouring part 501 and the wiping part 503 to be short. That is, since the thickness of the plated alloy layer may be made to be substantially uniform, a problem such as cracking or peeling of the plated layer hardly occurs.

Further, in the method according to the embodiment, the thickness of the plated layer may be easily adjusted by only adjusting the pressure of air or N₂ gas ejected from the wiping part 503. Incidentally, generally, with regard to the manufacturing of the plated steel sheet, the steel sheet is perpendicularly and rapidly raised from the molten metal pot in the case of so-called hot-dipping. At this time, the attachment amount of the molten metal which is raised together with the steel sheet by the viscosity is adjusted by the air or N₂ gas wiping. Generally, in this type of process, there is a need to increase the amount of raised molten metal by increasing a speed at which the steel sheet is raised, that is, a speed at which the sheet passes in order to increase the plating attachment amount. However, since the heating capability for plating the steel sheet is determined according to the condition of the facility, the sheet passage speed decreases in the case of the thick-walled steel sheet. Accordingly, the raised molten metal amount decreases, and the plating attachment amount may not be easily increased. In the inner-face metal-plating of the method according to the embodiment, the attachment amount may be controlled by the air or N₂ gas wiping pressure regardless or the amount of the raised molten metal and the thickness of the steel sheet in a manner such that the steel sheet passes in the horizontal direction instead of the perpendicular direction.

In a conventional method in which band steel is pulled in the vertical direction, molten metal naturally falls due to the effect of gravity and also, by performing wiping, a plated layer may easily be made thin. In the present method in which an object to be plated is allowed to pass (for example, plate leaping) in the horizontal direction, such an effect of gravity cannot be obtained and with an increasing amount of needed wiping, a thick plated layer is more likely to be formed (the plated layer is more easily cooled/set from a dipped portion of molten metal to wipings) (that is, in the present method, the thickness of a plated layer can easily be adjusted in the range of a thick plated layer, but adjustments of the thickness of a plated layer may be difficult in the range of a thin plated layer).

When an object to be plated is allowed to pass (for example, plate leaping) in the horizontal direction like in the present method, molten metal in the wiping part can be prevented from being cooled/set (molten metal is made to flow more easily) by presetting the temperature of the molten metal and the thickness of plating can be made thinner by increasing the amount to be wiped. However, the temperature of the molten metal is also involved in a reaction of an alloy layer of the played layer and if the temperature of the molten metal is made unnecessarily high, alloying of metal proceeds faster and it becomes more difficult to obtain a uniform high-quality plated layer.

When a conventional molten metal furnace is incorporated into the present method, the temperature range of molten metal in the molten metal bath varies enormously and thus, if an attempt is made to hold the temperature of the molten metal to cause a plating reaction properly, it is necessary to lower the control temperature to some extent to prevent the temperature of the molten metal from rising too high. Therefore, when the conventional molten metal furnace is incorporated into the present method, it is difficult in some cases to adopt a method of making the thickness of plating thinner by setting the temperature.

However, when a molten metal plating furnace according to the present invention is incorporated into the present method, the temperature of molten metal can be controlled precisely in a desirable range (range that is not excessive) of a higher temperature range of the molten metal (for example, the variation of temperature inside the plating bath can be controlled within 20° C.). Therefore, by incorporating the molten metal plating furnace according to the present invention, the molten metal can be made less likely to be cooled/set (the molten metal is made to flow more easily) during wiping and the amount of wiping can be increased also by the present method so that a plated layer that is uniform and made thinner can be formed more easily.

More specifically, the specified plating performing part into which the molten metal plating furnace according to the present invention is incorporated can easily make the thickness of a plated layer 4 μm or less also in the present method allowing an object to be plated to pass (for example, plate leaping) in the horizontal direction.

Incidentally, the effect of making a plated layer thinner (thinner plated layer by making the control temperature more precise) as described above is not limited to the inner surface plating treatment and is obtained from the outer surface plating treatment described below and also obtained from methods in general that allow an object to be plated to pass (for example, plate leaping) in the horizontal direction like the present method. Further, the effect is obtained from methods (for example, the conventional method of pulling in the vertical direction) other than methods that allow an object to be plated to pass (for example, plate leaping) in the horizontal direction (that is, plating made still thinner can be obtained).

Next, even in the outer-face plating treatment, the dipping length of the molten metal is important. The thickness of the outer-face plated alloy layer may be adjusted in a manner such that molten metal is charged into the dipping part(s) by the number of the dipping part(s) necessitated to obtain the required thickness of the plated alloy layer among the plural outer-face molten metal-plating devices. Further, due to adjusting the thickness of the plated alloy layer in this way, even when the line speed changes, the thickness of the plated alloy layer of the outer face may be maintained to be uniform.

Furthermore, from the viewpoint of bending workability, the thickness of the alloy layer is desirably 4 μm or less, is more desirably 3 μm or less, and is further more desirably 2 μm or less. When the thickness of the alloy layer is set to be within this range, cracking or peeling of the plating hardly occurs due to the bending. Here, in order to adjust the thickness of the alloy layer, the plating dipping time is desirably 1 second or less, is more desirably 0.3 seconds or less, and is further more desirably 0.25 seconds or less.

FIG. 20 shows the relationship between the molten metal dipping length and the plating speed when the plating performing part is not a specified plating performing part and the alloy layer is set to 1 μm. Here, the plating speed herein indicates the length of the steel pipe to be plated in the continuous line per minute, and is equal to the pipe manufacturing speed (the line speed). That is, when the thickness of the alloy layer needs to be maintained to be 1 μm, the dipping length of the molten metal may be set so as to satisfy the relation of FIG. 20 depending on a change in the line speed.

In the system for producing a steel pipe in the present embodiment, therefore, even if the line speed is changed, the thickness of the alloy layer is made constant by focusing on the molten metal dipping length. Further, as described above, the temperature of the molten metal can be controlled more precisely by selecting a specified plating performing part as the plating performing part and thus, the specified plating performing part is less subject to variation of the temperature of molten metal. Therefore, conditions for forming an alloy layer to a specific thickness can be determined more precisely (on the other hand, it is difficult to obtain correct data when the temperature of molten metal varies) in a preliminary test stage in which the relationship between the molten metal dipping length and the plating speed as shown in FIG. 20 is determined. In addition, by controlling the temperature of molten metal more precisely, reproducibility of preliminary conditions (relationship between the molten metal dipping length and the plating speed to obtain a specific thickness of alloy layer) obtained in a preliminary test is made superior (the influence of variation of the temperature of molten metal on the thickness of alloy layer is curbed so that the target thickness based on preliminary conditions can be achieved more easily).

Here, the invention is not limited to the above-described embodiment. For example, in the embodiment, although the molten metal-plated layer is formed on both inner and outer faces using the melting device, the molten metal-plated layer may be formed on only the inner face or the outer face using the molten metal-plating device.

Further, the upper face of the outer-face plated layer may be coated with a protection coating using a synthetic resin. In this way, the rust preventing effect of the molten metal-plated steel pipe may be further improved.

Furthermore, in the embodiment, the plating performed on the steel pipe is not particularly limited, and for example, zinc may be exemplified. However, if necessary, other metal may be applied. Further, the embodiment has been described on the assumption that the steel sheet is used, but the invention may be applied on the assumption that other metal sheets are used. As such a metal sheet, for example, a copper tape, an aluminum tape, or the like is supposed, but the invention is not limited thereto.

In order to examine the variation in temperature of the molten metal plating furnace, the following experiment has been conducted.

### Example 1

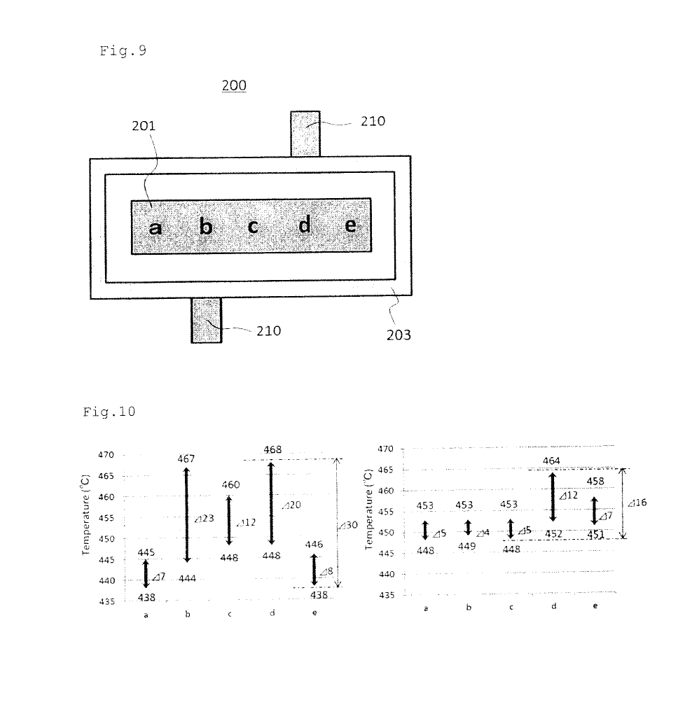

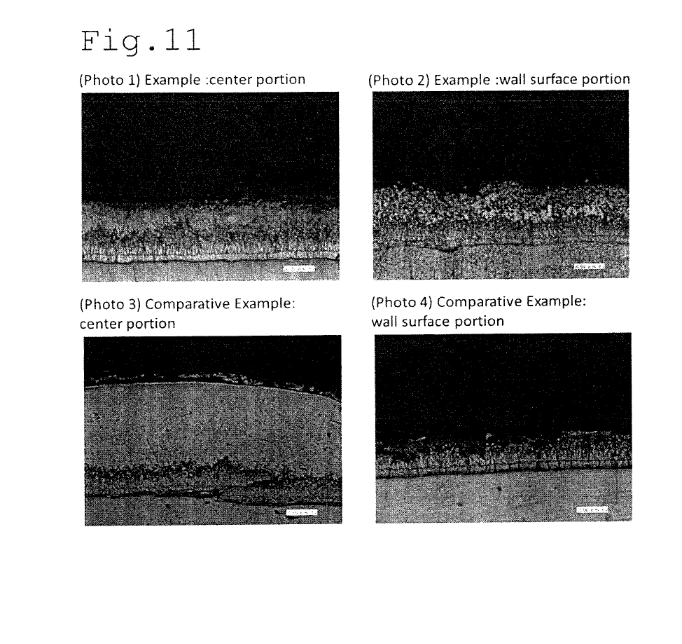

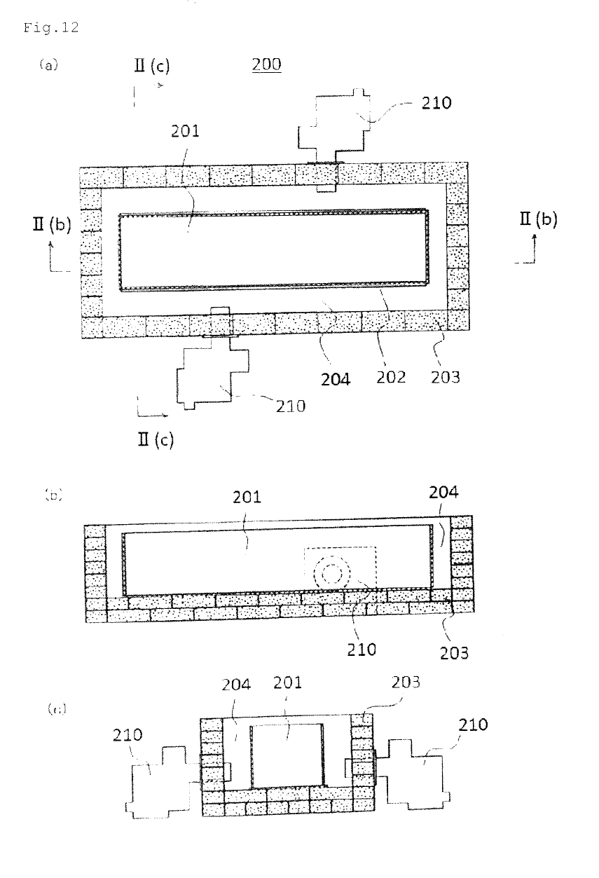

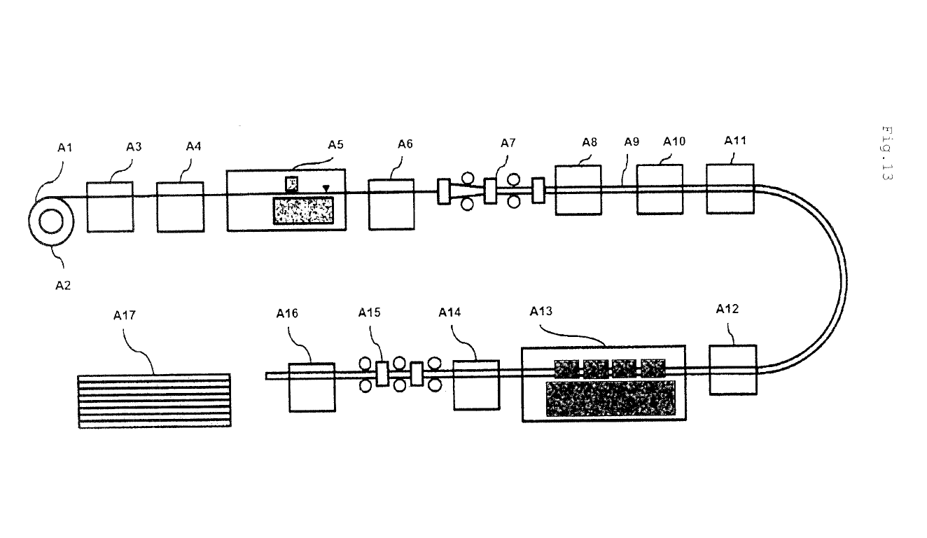

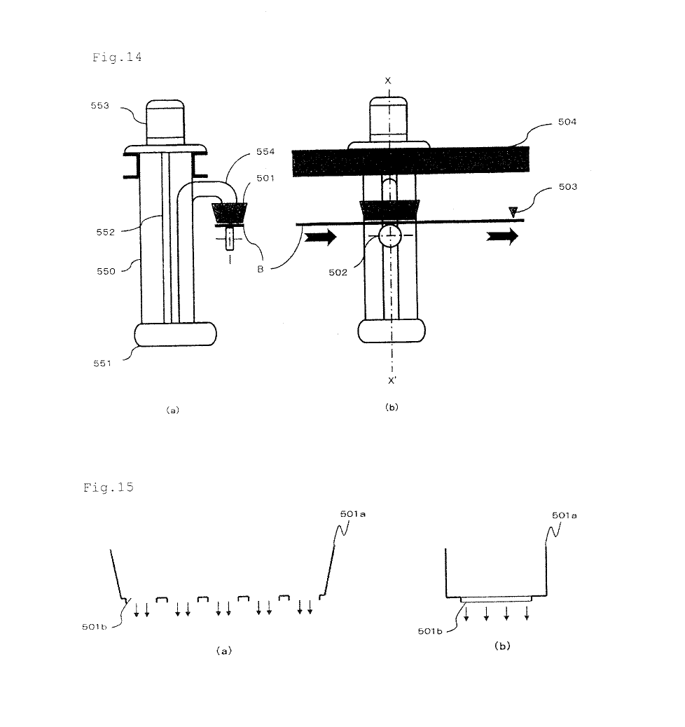

Using the molten metal plating furnace 100 including the heating device 10 illustrated in FIG. 8, zinc is molten in the zinc bath inside the iron pot 101, provided the controlled temperature at the center of the bath is 450° C., and the temperatures of the molten zinc are measured at five places (a, b, c, d, and e) in the zinc bath (plating bath) at the time of soaking (the controlled temperature is controlled by setting c as the reference point of temperature). The minimum temperature and the maximum temperature of the measured temperatures at respective places are plotted on the graph (illustrated in FIG. 10A). Note that the heating device 10 of this metal plating furnace is a heating device employing a certain heating system which can make kinetic energy stored in combustion gas molecules generated by combustion collide and vibrate so as to convert it into thermal energy.

### Comparative Example

The temperature of molten metal is measured in the same manner as the example except that the metal plating furnace 200 illustrated in FIG. 9 is used. Namely, zinc is molten in the zinc bath inside the iron pot 201, provided the controlled temperature is 450° C., and the temperatures of the molten zinc are measured at five places (a, b, c, d, and e) in the zinc bath (plating bath) at the time of soaking. The minimum temperature and the maximum temperature of the measured temperatures at respective places are plotted on the graph (illustrated in FIG. 10B). Note that the heating device 210 of this metal plating furnace is a conventional burner.

As apparent from the graphs of FIG. 10A and FIG. 10B, with respect to the controlled temperature of 450° C., the difference between the minimum temperature and the maximum temperature is 16° C. in the example of the present invention, and the variations in temperatures among the five places are small. On the other hand, in the comparative example, the difference between the minimum temperature and the maximum temperature is 30° C. and the variations in temperatures among the five places are found to be large. Namely, compared to the plating furnace including the conventional burner of the conventional heating system, the plating furnace of the example employing the novel heating system of the present invention is found to be excellent in temperature controllability and high in temperature uniformity of molten metal in the bath.

Additionally, zinc plated products have been made using the plating furnaces shown in the example and the comparative example. Note that the bath temperature upon plating is controlled from 450° C. to 453° C. (temperature control in which the center of the bath is the reference point of temperature). Further, the pulling-up speed is 200 mm/s, and the plating time is 120 s. The results are illustrated in Table 1, Table 2 and FIG. 11 (Photos 1 to 4) showing that the plated products of the example tend to be less in fluctuation of deposition amount of plating according to positions in the bath and less in variation of thickness of alloy layers. For example, with respect to the difference of average thickness of plating samples plated at the center and the wall surface portion of the bath, 0.47 μm for the plated products of the example while 50.95 μm for the plated products of the comparative example (refer to Table 1 and Table 2). Note that Photo 1 and Photo 2 are photographs of the case that plated products are made using the plating furnace including the heating device employing the specified heating system according to the present invention. Photo 1 is a photograph of a plated product plated near the center of the bath, and Photo 2 is a photograph of a plated product plated near the wall surface of the bath. Photo 3 and Photo 4 are photographs of the case that plating is made using the plating furnace including the conventional burner. Photo 3 is a photograph of a plated product plated near the center of the bath, and Photo 4 is a photograph of a plated product obtained by plating near the wall surface of the bath. Note that in order to eliminate difference of the experiment condition between the center and the wall surface portion, a jig which can simultaneously perform plating to two samples at different places is used.

TABLE 1
measurement result: thickness of plating and alloy layer (Example)

| | | the heating system according to the present invention | | | | | | | | | | |
|---|---|---|---|---|---|---|---|---|---|---|---|---|
| | | | | | | | | | | | variation of the center | |
| | | | | | | | | | | | and the wall surface | |
| Heating device | | | | | | | | | | | difference | standard |
| experimenter | | A | | | | B | | | | average | of average | deviation |
| thickness of | near the | 75.55 | 68.28 | 64.36 | 59.88 | 79.85 | 79.84 | 72.38 | 77.42 | 72.20 | 0.47 | 8.18 |
| plating (μm) | center | | | | | | | | | | | |
| | near the | 64.55 | 65.85 | 84.32 | 87.68 | 64.55 | 60.63 | 71.08 | 75.18 | 71.73 | | |
| | wall | | | | | | | | | | | |
| | surface | | | | | | | | | | | |
| thickness of | near the | 30.04 | 25.00 | 24.26 | 23.32 | 30.78 | 27.05 | 28.17 | 26.12 | 26.84 | 2.42 | 3.08 |
| alloy layer | center | | | | | | | | | | | |
| (μm) | near the | 28.17 | 28.54 | 35.44 | 32.65 | 25.56 | 25.74 | 28.86 | 29.10 | 29.26 | | |
| | wall | | | | | | | | | | | |
| | surface | | | | | | | | | | | |

TABLE 2
measurement result: thickness of plating and alloy layer (Comparative Example)

| | | the heating system according to the conventional method | | | | | | | | | | |
|---|---|---|---|---|---|---|---|---|---|---|---|---|
| | | | | | | | | | | | variation of the center | |
| | | | | | | | | | | | and the wall surface | |
| Heating device | | | | | | | | | | | difference | standard |
| experimenter | | A | | | | B | | | | average | of average | deviation |
| thickness of | near the | 127.79 | 130.77 | 133.20 | 143.83 | 71.08 | 69.21 | 88.05 | 87.49 | 166.43 | 50.95 | 33.06 |
| plating (μm) | center | | | | | | | | | | | |
| | near the | 46.64 | 44.59 | 48.13 | 48.32 | 61.75 | 63.80 | 66.41 | 64.17 | 55.48 | | |
| | wall | | | | | | | | | | | |
| | surface | | | | | | | | | | | |
| thickness of | near the | 33.77 | 44.03 | 35.82 | 41.41 | 34.51 | 35.44 | 42.16 | 34.89 | 37.75 | 6.48 | 5.65 |
| alloy layer | center | | | | | | | | | | | |
| (μm) | near the | 24.44 | 27.24 | 24.25 | 30.22 | 36.75 | 37.50 | 31.90 | 37.87 | 31.27 | | |
| | wall | | | | | | | | | | | |
| | surface | | | | | | | | | | | |

From the above results, the followings have been verified.

Namely, the molten metal plating furnace including the heating device which employs the specified heating system according to the present invention is less in the variation of temperature in the furnace and excellent in the temperature controllability. Furthermore, alloying of contact portions with zinc inside the iron pot can be suppressed, thereby enabling occurrence of dross to be suppressed. This leads to improvement in plating quality due to the reduced dross impurities and also leads to reduction in regular dross pump-up work, thereby realizing improvement in work efficiency.

Further, in the molten metal plating furnace of the present invention, the temperature difference in the plating furnace is small and the less load is given to the pot so as to prevent the oxidation corrosion of the outer wall of the pot and suppress alloying of the inner wall of the pot, thereby enabling the cost to be reduced due to the prolonged lifetime of the pot.

Furthermore, in the molten metal plating furnace of the present invention, the temperature uniformity in the plating furnace is high which leads to uniformization of plating reactions, thereby enabling the variation in plating quality to be suppressed. This is also supported by the measurement results of the deposition amount of plating through the production of plated products.

The molten metal plating furnace of the present invention can produce plated products which are excellent in plating quality; therefore it can be applied to production of high-grade plated products as well. Further, as it can perform plating at lower temperature than that of the conventional plating furnace (as the variation in temperature of molten metal according to positions in the bath is small, and the controlled temperature for guaranteeing a melting temperature can be set as low as possible), there are more choices of objects to be plated, thereby enabling various objects to be plated. Further, the work efficiency of the system and plating quality can be improved by properly incorporating the molten metal furnace into the system for producing a metal-plated product.

### REFERENCE SIGNS LIST

10 Heating device (Combustor)
100 Molten metal plating furnace
101 Plating bath
200 Conventional molten metal plating furnace
201 Plating bath
202 Inner wall
203 Heat-resistant outer wall
204 Heating chamber
210 Conventional burner
A1 coil
A2 uncoiler
A3 shot blasting device
A4 pretreatment device
A5 inner-face molten metal-plating device
A6 first cooling trough
A7 forming device
A8 welding device
A9 tubular body
A10 bead cutting device
A11 flux applying device
A12 preheating device
A13 outer-face molten metal-plating device
A14 second cooling trough
A15 sizing device
A16 cutting device

1. A molten metal plating furnace comprising:
a plating bath;
an inner wall disposed outside of the plating bath;
a heat-resistant outer wall in a substantially rectangular shape made of a short wall portion and a long wall portion;
a heating chamber surrounded by the inner wall and the heat-resistant outer wall; and
a heating device disposed on at least one place of the heat-resistant outer wall,
wherein the heating device is the combustor (10) including a combustion chamber (12) extending regularly about a central axis (14) of which at least part of the axially extending wall (26, 64, 66) is formed with an array (22) of fuel charging orifices (28.1) and an array (24) of air charging orifices (28.2) facing to discharge fuel and air into a common combustion zone along the combustion chamber (12) with the sizes of the fuel charging orifices (28.1) standing in an appropriate relationship to those of the air charging orifices (28.2) to achieve an effective combustion reaction, a progressively constricted combusted medium discharge nozzle (16) for accelerating the discharge velocity of combusted medium, and a combustion fuel and air supply disposition (20, 18) opening respectively into the fuel charging orifice array (22) and the air charging orifice array (24) each being connectable to a supply of the relevant medium, whether fuel or air, while the combustion chamber (12) is exposable to igniting means (34) for igniting a combustible mixture once the combustor is in use; characterised in that the effective cross sectional orifice size of at least the majority of orifices (28) of at least one of the orifice arrays (22, 24) is controllably adjustable by means of an adjustment mechanism (30, 44, 46, 48, 58, 68, 70, 76) for adjusting the extent of the appropriate medium charging orifice array (22, 24) though enabling the independent adjustment of the arrays in the case of the sizes of both the orifice arrays being adjustable.

2. The molten metal plating furnace claimed in claim 1, wherein the individual orifices (28) of the arrays (22, 24) of the heating device are positioned and aimed to result in the central axes (40) of at least the majority of air charging orifices (28.2) crossing the central axes (38) of corresponding fuel charging orifices (28.1) along the longitudinal centre (14, 42) of the combustion chamber (12) that corresponds with its the central axis (14).

3. The molten metal plating furnace claimed in claim 1, wherein the medium charging orifice arrays (22,24) of the heating device each has an equal number of orifices (28).

4. The molten metal plating furnace claimed in claim 1, wherein the orifices (28) of the arrays (22,24) of the heating device are regularly spaced.

5. The molten metal plating furnace claimed in claim 1, wherein the orifices (28) of the arrays (22, 24) of the heating device are spaced in rows and columns.

6. The molten metal plating furnace claimed in claim 2, wherein all the central axes (38,40) of the orifices (28) of the heating device are slanted at the same angle relative to the longitudinal centre (14, 42) of the combustion chamber (12) in the discharge direction of the heating device.

7.-21. (canceled)

22. A method for producing the molten metal plated product using the molten metal plating furnace claimed in one of claims 1 to 6.

23. The method for producing the molten metal plated product claimed in claim 22, wherein the variation in temperature in the plating bath of the molten metal plating furnace is not greater than 20 degrees.

24. A system for producing a metal-plated product comprising at least one plating performing part that performs molten metal plating on an object to be plated, wherein
the plating performing part has a plating bath and a heating device to heat the plating bath;
at least one of the plating performing part includes a plating bath and a heating device to heat the plating bath; and
the heating device is the combustor (10) including a combustion chamber (12) extending regularly about a central axis (14) of which at least part of the axially extending wall (26, 64, 66) is formed with an array (22) of fuel charging orifices (28.1) and an array (24) of air charging orifices (28.2) facing to discharge fuel and air into a common combustion zone along the combustion chamber (12) with the sizes of the fuel charging orifices (28.1) standing in an appropriate relationship to those of the air charging orifices (28.2) to achieve an effective combustion reaction, a progressively constricted combusted medium discharge nozzle (16) for accelerating the discharge velocity of combusted medium, and a combustion fuel and air supply disposition (20, 18) opening respectively into the fuel charging orifice array (22) and the air charging orifice array (24) each being connectable to a supply of the relevant medium, whether fuel or air, while the combustion chamber (12) is exposable to igniting means (34) for igniting a combustible mixture once the combustor is in use; characterised in that the effective cross sectional orifice size of at least the majority of orifices (28) of at least one of the orifice arrays (22, 24) is controllably adjustable by means of an adjustment mechanism (30, 44, 46, 48, 58, 68, 70, 76) for adjusting the extent of the appropriate medium charging orifice array (22, 24) though enabling the independent adjustment of the arrays in the case of the sizes of both the orifice arrays being adjustable.

25. The system claimed in claim 24, wherein the individual orifices (28) of the arrays (22, 24) of the heating device are positioned and aimed to result in the central axes (40) of at least the majority of air charging orifices (28.2) crossing the central axes (38) of corresponding fuel charging orifices (28.1) along the longitudinal centre (14, 42) of the combustion chamber (12) that corresponds with its the central axis (14).

26. The system claimed in claim 24, wherein the medium charging orifice arrays (22,24) of the heating device each has an equal number of orifices (28).

27. The system claimed in claim 24, wherein the orifices (28) of the arrays (22,24) of the heating device are regularly spaced.

28. The system claimed in claim 24, wherein the orifices (28) of the arrays (22, 24) of the heating device are spaced in rows and columns.

29. The system claimed in one of claim 25, wherein all the central axis (38,40) of the orifices (28) of the heating device are slanted at the same angle relative to the longitudinal centre (14, 42) of the combustion chamber (12) in the discharge direction of the heating device.

30.-44. (canceled)

45. The system claimed in any one of claims 24 to 29, wherein the metal-plated product is a metal-plated steel pipe.

46. The system claimed in any one of claims 24 to 29, wherein
the system for producing the metal-plated product is a steel pipe producing system that produces a steel pipe plated with molten metal on inner and outer surfaces or one of the surfaces on a continuous production line from band steel, the system comprising:
an inner surface plating performing part that performs the molten metal plating by pouring molten metal onto an upper side of the band steel of a side corresponding to an inner surface of the steel pipe;
a steel pipe forming part to obtain a continuous steel pipe by continuously cold-forming the band steel in a tubular shape having the inner surface plated and seamlessly welding longitudinal-direction end face junctions of the band steel formed as the steel pipes; and
an outer surface plating performing part that performs the molten metal plating by dipping an outer surface of the steel pipe into the molten metal, wherein
the inner surface plating performing part and/or the outer surface plating performing part includes the plating bath and the heating device to heat the plating bath.

47. A method for producing the metal-plated steel pipe using the system claimed in any one of claims 24 to 29.

48. The method for producing the metal-plated steel pipe claimed in claim 47, wherein the variation in temperature in the plating bath of the molten metal plating furnace is not greater than 20 degrees.

49. The metal-plated steel pipe obtained by the method claimed in claim 47, wherein a thickness of the plated layer is 4 μm or less.
